(19) United States
(12) Patent Application Publication
(10) Pub. No.: US 2008/0041859 A1
(43) Pub. Date: Feb. 21, 2008

(54) Modular Transportable Heating Device

(76) Inventor: Casper Teglbjarg, Natraby (SE)

Correspondence Address: DENNISON, SCHULTZ & MACDONALD, 1727 KING STREET, SUITE 105, ALEXANDRIA, VA, 22314, US

(21) Appl. No.: 11/570,146

(22) PCT Filed: Jun. 7, 2005
(86) PCT No.: PCT/SE05/00874

§ 371 Date: Mar. 6, 2007

(30) Foreign Application Priority Data
Jun. 8, 2004 (SE) 0401476-7

(51) Int. Cl. B65D 83/72; A61J 9/00

(52) U.S. Cl. 220/592.16; 219/387

(57) ABSTRACT

During journeys, and at other times when no stationary heating devices such as microwave ovens or hotplates are available, providing hot foods, liquid or solid, can be problematic. By providing a container with an in-built heating arrangement, the present invention solves the problem. Furthermore, the container is of a modular design. Its parts are easily interchangeable and new configurations for different purposes can be readily put together.

### BACKGROUND TO THE INVENTION

The present invention is based on a modular, portable heating device such as a baby's feeding bottle with an in-built heat source. As a rule, one part of such a feeder is a plastic bottle, or a bottle of a different material. Using any suitable method (e.g. a screw thread) a teat can be fitted to the bottle's opening. As a rule, the feeding bottle's contents (e.g. formula milk) have to be heated before they are served to a baby. This often entails a good deal of bother for the person taking care of the baby. Two common heating methods are to place the feeding bottle in a saucepan of hot water or in a microwave oven. This can present problems when the carer wishes to go on an outing, travel somewhere or visit friends. The concern that it may not be possible to provide warm milk for the baby may even result in the avoidance of such activities. Furthermore, it is important that the contents can be heated to a specific temperature that is neither too cold nor too hot. There are also other occasions/situations where a heated drink would be welcome, but where, for a range of practical or psychological reasons, the person wishing to have a hot beverage does not want to drink it from a feeding bottle.

### DESCRIPTION OF THE INVENTION

The aim of the present invention is that it should result in a container that has a cavity (e.g. cylindrical) into which a heat source can be introduced so that, through contact between the shells of the cavity and the heat source, heat can be transferred to the container and its contents. Furthermore, the heat source is to be an energy-storing cartridge that can be turned on whenever the user so wishes. Of course, it would also be possible to have variant in which, like an ordinary kettle, a heating element is in direct contact with the liquid inside the container. The previously mentioned cavity may be suitably located at the base of the container, but it is, of course, equally feasible to have the cavity along the sides, or running from the top, of the container. Here, it is convenient to attach the heating unit to the container by means of a screw thread. The heating unit can be of any suitable type whatsoever. Thus, the unit could be a battery connected to a heat-generating resistance wire. Another way of generating warmth is to use two different substances that, when mixed, give off heat. Water and calcium chloride are two possible substances here. The container itself is characterised by its modular build and the possibility of constructing different variants by combining different, shared subcomponents. This has the advantage that the manufacture of different variants (e.g. a heated coffee mug or heated feeding bottle) is greatly simplified by the fact that, to a considerable extent, the products share a common design. Furthermore, a product with several areas of application can be provided, the consumer thus not being obliged to buy a completely new apparatus for each application. Of course, the invention is not restricted to having a modular design. Modularity is simply a worthwhile property.

In certain cases, after heating of the container's contents has finished, it may be necessary to keep the contents hot for a predetermined length of time. This can be achieved if the container has the properties of a vacuum flask. All, or nearly all, sections of the container's walls can have such properties (the exceptions being those surfaces in direct contact with the cavity running from the container's base). Consequently, the container's walls can be constructed in exactly the same way as those of a conventional vacuum flask. Another way of securing an identical result is to give the outside of the container's outer wall a coating that achieves the same effect as a vacuum flask. In this case, the cavity's shell must not be coated. Giving an ordinary vacuum flask both a cavity that runs from its base and a portable heat source is also a possible application for the invention. This would improve the heat-retaining properties of the vacuum flask and allow contents to remain hot for a longer period than they would if there were no heating cartridge.

A further feature of the invention is that it has a temperature sensor and a temperature regulator. These have the function of ensuring that the contents are heated to a selected temperature. Achieving a certain temperature is very important when heating, for example, food for babies. Parents using traditional heating methods can find this problematic—heating is either excessive or insufficient. The invention thus solves this problem too.

Yet a further variant is to replace the heating cartridge with a cooling cartridge that will keep container contents cold. The cooling cartridge could, for example, be a Peltier element. However, it could also be a liquid-filled cartridge that, before insertion in the container, is cooled in a freezer. Here, it is advantageous that the vacuum flask properties referred to above are given to the outside of the container. The result is a portable, cold drinks container.

A further possibility is to build protected electrical coils into the sleeve around the container. These can then be used to heat the container from the outside. Heating the container from its sides as well as from inside the cavity achieves a more even temperature distribution. This can be appropriate where, for example, the container's contents are of a more viscous nature and, consequently, diffuse heat less rapidly than liquids. Heating potato puree in the container is an example. However, the invention does of course work with other types of purees and foods,

In one variant of the invention, the base of the container is of a heat-resistant material. Besides being heated via the heating cartridge, contents can here also be heated by placing the container directly on an ordinary hotplate.

If a battery and a resistance circuit are used for heating, a container charging module can advantageously be supplied. The module can be either built into the container or kept separate. In the latter case, the container would be charged by placing it on the charging module. The advantage of having an in-built module is that it dispenses with the need to carry around a separate charging module—an ordinary lead is sufficient. It is also a less cumbersome solution, The disadvantage here is that the bottle, as a whole, is somewhat heavier and larger.

A further variant is to use a plug/socket arrangement that is compatible with mobile chargers. Most mobile telephones have their own contact arrangements for their chargers. The invention could thus be adapted for sale for use with various makes of mobile telephone.

It is also possible that, using a lead, the charger could be connected to a socket (e.g. the cigarette lighter socket) in a car.

In one variant, the container has solar cells on its outside. These solar cells charge the heating cartridge and reduce the frequency with which it is necessary to charge the cartridge via a conventional socket.

In a further variant, the charger can be an integral part of a car. The container can then be used with this in-built module. The module can be sited at various points in a car. In one model, the container is a mug that is placed in a charging module in a car and in which a lid (also built into the car) automatically comes down over the mug and prevents liquid spilling therefrom. It also improves heat conservation and speeds the heating process (i.e. the heat is held in by the lid).

Yet a further variant is a container for a bicycle. This would allow a drink to be kept warm throughout a bicycle ride or tour. The bicycle could have a charging module that charges the cartridge via either solar cells on the bottle and/or the bicycle and/or via a dynamo that is powered by the rotation of the bicycle's wheels or pedals.

Where the container's heating or cooling properties are not required, a normal base module could be used instead of the container base module. The former does not have the above-mentioned cavity and thus functions as an ordinary base. In other words, using the feeding bottle example, the container becomes an ordinary (apart from its modular characteristics) feeding bottle. This has the advantage that, for example, a family with a young child does not need to buy one feeding bottle for use on journeys and one for use at home. Without the cavity, the bottle holds more and it is thus an advantage to have a normal base module for those situations where a portable heating or cooling source is not required. The bottle can then, of course, be heated in a microwave oven.

If a normal base module is not available and the user wishes to heat the container in a microwave oven, then it suffices to screw the base module (which holds the heating cartridge) off the container base module. The container is thus relieved of all the metal parts in the heating cartridge and can be put in a microwave oven.

Another advantage of being able to screw off the base module is that, following cartridge heating, the base module and heating cartridge can be removed to give a lighter mug/feeding bottle.

### SHORT DESCRIPTION OF THE FIGURES

FIG. 1 gives an overview of a container, here a feeding bottle, with its modules.

FIG. 2 gives an overview of a container, here a mug, with its modules.

FIG. 3 shows two-mugs, a feeding bottle and a variety of handle/grip arrangements that can be used with these.

FIG. 4 gives an overview of various mug variants.

FIG. 5 gives an overview of a feeding bottle where the container base module and the top module have been put together. It also shows the design of the heating cartridge.

FIG. 6 shows a mug intended for use inside a vehicle.

FIGS. 7-9 show battery-heated models of feeding bottles and mugs.

FIGS. 10-16 show another design (with cavity and mug) for a battery-heated model of a feeding bottle.

FIGS. 17-21 show yet another design (with mug) for a battery-heated model of feeding bottle.

FIGS. 22-26 show a design (with mug) for a feeding bottle heated by mains electricity.

FIGS. 27-34 show a design (with mug) for a gas-heated feeding bottle.

FIGS. 35-37 show a design (with mug) for a chemically heated feeding bottle.

FIG. 37 shows a reference illustration of a feeding bottle and mug with a heating device.

These figures are used below to illustrate the various designs.

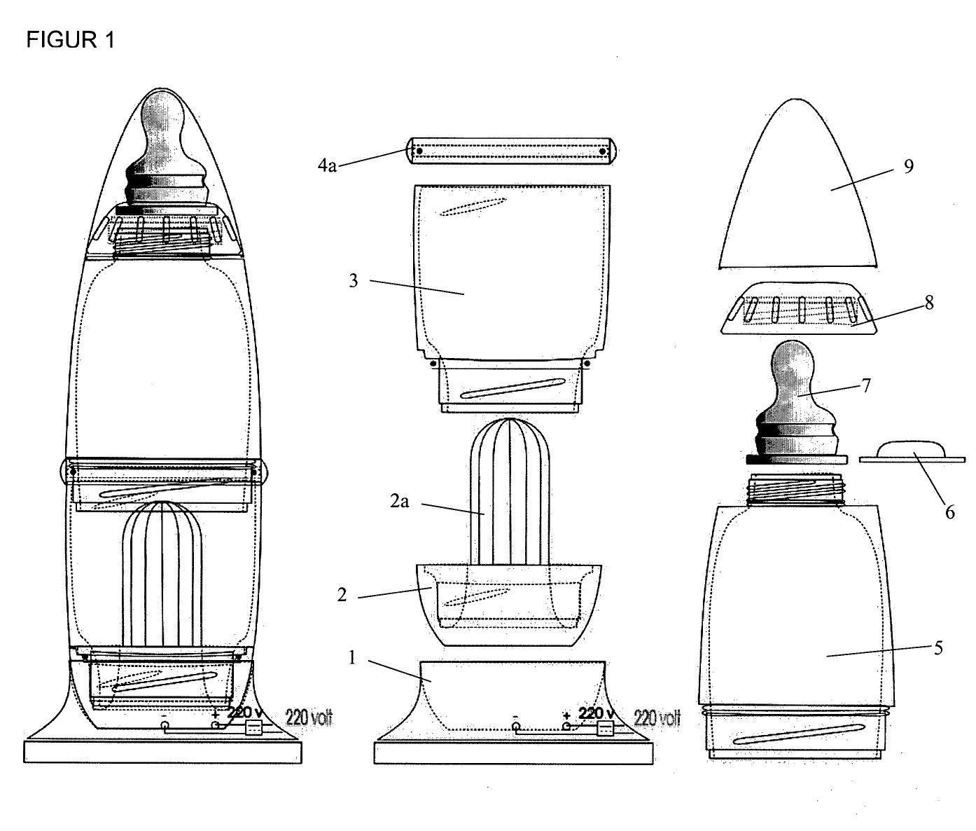

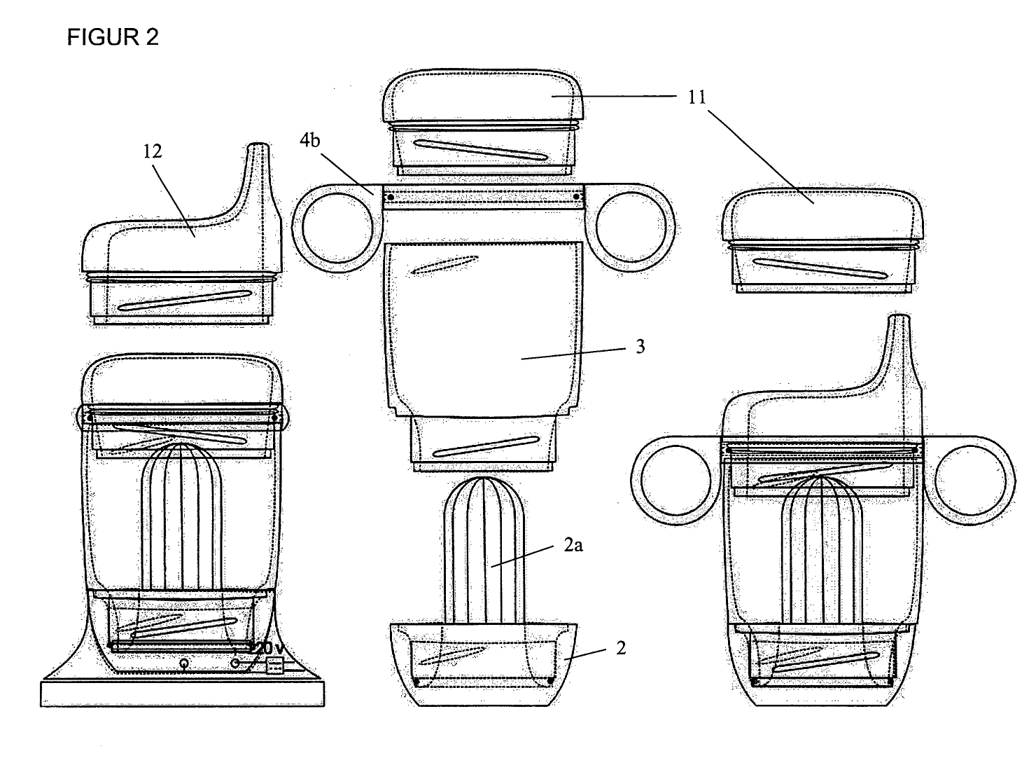

FIGS. 1 and 2 show examples of the modular construction of the present invention. FIG. 1 shows how a feeding bottle is built from the modules and FIG. 2 shows how the modules can form a mug. Three of the modules are common to both these figures, i.e. a common charging module (1), a common base module (2) that includes a heating cartridge (2a) and a common container base module (3). The numbering is consistent between the figures. These three parts can be put together to form a base unit that is common to both the feeding bottle and the mug. The unit is thus composed of the charging module (1), base module (2) and the container base module (3). Various units can then be added to this base unit, thereby giving the invention a range of uses. We have chosen to use the terminology that units are put together from modules. As shown in FIG. 1, a feeding bottle unit can be added to the base unit so that the invention forms a feeding bottle with an in-built heating cartridge (2a). As shown in FIG. 2, a mug unit can be added to the base unit so that the invention forms a mug with an in-built heating cartridge.

Normally, the charging module (1) is of a design that stands firmly on a horizontal surface. However, variants where the charging module can be affixed to a non-horizontal surface such as a wall or a panel in a car are also possible. In its basic format, charging module 1 is designed to be connected (via a lead) to a mains electricity supply. The charging module has a transformer unit that converts the current from alternating to direct and adjusts the voltage to a suitable value for charging a battery. Charging module 1 thus functions in the same way as the charging unit for a mobile telephone, with the difference that the battery is here used for a heating cartridge (2a). The top of the charging module (1) is shaped like a flat-bottomed bowl. The bowl's flat bottom has projecting contacts and is designed so that the bottom of the feeding bottle or mug sits stably during charging (electrical contact is made via the contacts). The common base module (2) is designed to fit into the bowl-shaped charging module (1) and, in its bottom, has sockets to receive the charging module's projecting contacts. The base module comprises a bowl-shaped part, from the centre of which a heating cartridge (2a) projects, The inside of this bowl-shaped part has a screw thread that receives the reciprocating thread on the container base module (3). The heating cartridge (2a) is a component that projects from the base module and which, in this version, holds a rechargeable battery that is connected to a heating coil in the cartridge. Via a switch and a temperature control (either fully variable or with predetermined levels that can be, for example, set to give optimum temperatures for baby food), current enters the heating coil. This becomes hot and, via the surfaces of the heating cartridge's (2a) shell, the heat is transferred to the surfaces of the container base module's (3) shell. This results in the heating of the container's contents. The container base module (3) comprises a container, the bottom of which has a “foot” (i.e. a narrower section) with a screw thread that allows the container base module (2) to be screwed onto the base module (2). In its bottom, the container base module (3) also has a cavity that is designed to receive the heating cartridge (2a). The inside of the top of the container base module (3) has a screw thread that can receive the reciprocating thread of a feeding bottle unit or of a mug unit. The controls for switching on heating cartridge 2a can be sited on either the side or the lower part of base module 2 or, alternatively, on the side of container base module 3. In the latter case, electrical contact must also be provided in the arrangement for connecting the container base module (3) to the base module (2).

FIG. 1 shows the base unit and the feeding bottle unit. The feeding bottle unit comprises a “grip ring” (4-a, b or c), a top module (5), a teat (7), a transport lid (6), a fastening ring (8) and a cap (9). Top module 5 is a cylinder-shaped component that, at its base, has a “foot” (i.e. a narrower section) with an external (i.e. male) screw thread and, at its top, a neck with an external thread. To form a recess that can accommodate a “grip ring” (4) when the top module (5) is screwed to the container base module (3), there is a further narrowing in the “foot” of the top module, Grip ring 4 can be plain, i.e. with no “handle function” (e.g. 4a in FIG. 1) or, as 4b in FIG. 2, have some form of handle(s). A teat (7) or a transport/protection lid (6) can be fitted to the top module (5). Both are held in place by screwing the conical fastening ring (8) to the top module (5). Fastening ring 8 has a screw thread on its inside and small, projecting lugs on its outside. These allow the cap (9) to be fitted.

FIG. 2 shows the base unit and the mug unit. The mug unit comprises a “grip ring” (4-a, b or c), a lid module (11) and a drinking spout module (12). It is intended that the lid module (11) should be used when, for example, the mug is being transported while it is holding a liquid (or a puree like food) and a drinking spout is not required. Lid module 11 has, at its base, a “foot” that has a screw thread on its outside. This screws into the reciprocating thread on container base module 3. A “grip ring” (4) can be fitted between lid module 11 and container base module 3. Lid module 11 is a cylinder-shaped component that, at its top, has a lid that, as need dictates, can be pushed into place or removed. Drinking spout module 12 is intended for users who wish to drink from a mug but, in order to hinder spillage, also want the liquid to flow via a restricted aperture. This may be a particular advantage for young children. However, other users may also find such a model to be of interest. Drinking spout module 12 has, at its base, a “foot” that has a screw thread on its outside. This screws into the reciprocating thread on container base module 3. A “grip ring” (4) can be fitted between drinking spout module 12 and container base module 3. At its top, drinking spout module 12 is “covered” by a projecting drinking spout.

A small cap could also, of course, be fitted to the spout.

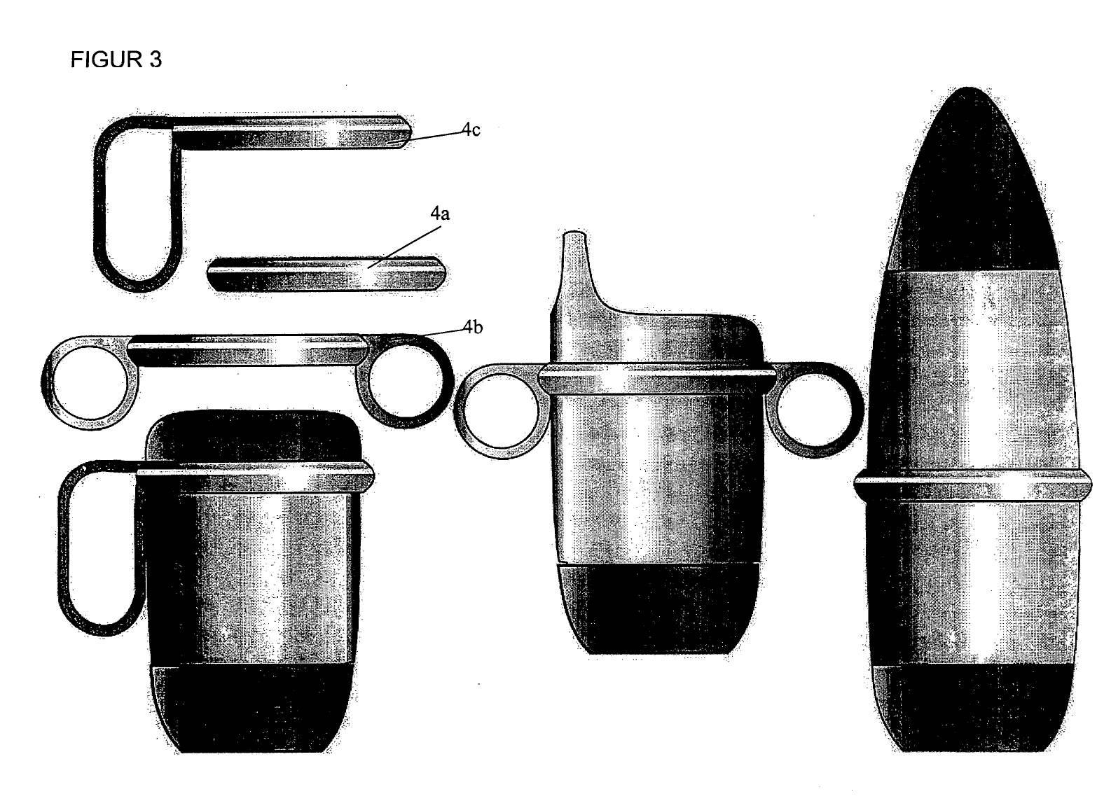

FIG. 3 shows a mug with a lid module (11), a mug with a drinking spout module (12), a feeding bottle and three variants (4a, 4b and 4c) of the “grip ring”. These particular illustrations demonstrate the invention assembled for practical use.

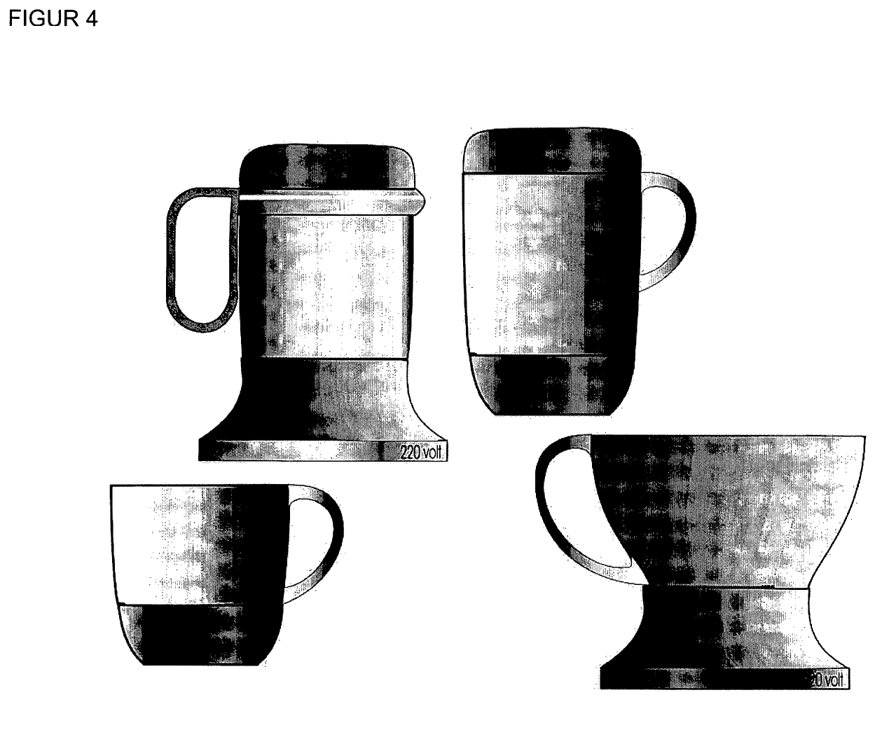

FIG. 4 shows four different mug variants, each ready for practical use and able to use the same charging module.

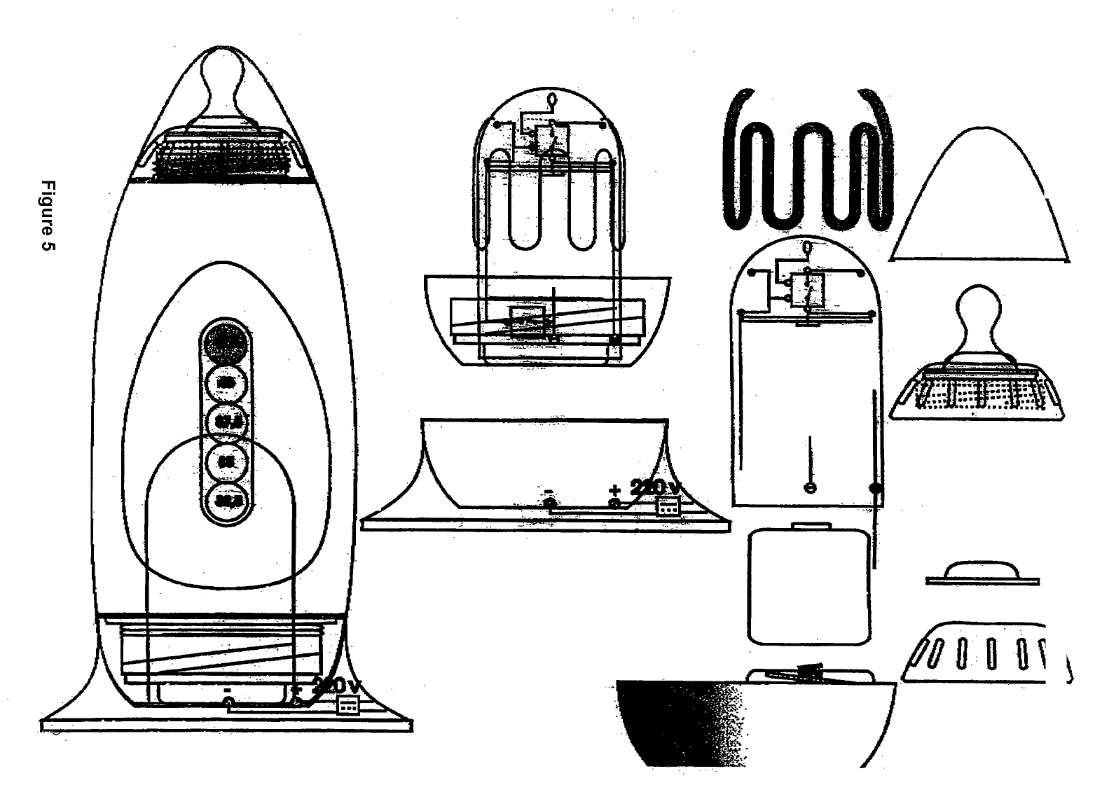

FIG. 5 shows a feeding bottle formed by joining the container base module and the top module to a feeding bottle body. The feeding bottle body has electrical contacts (13) and, on its outside, controls (14) for activating heating and regulating the temperature. The heating cartridge comprises a battery (15) connected to a circuit with a resistance (16) and a thermostat (17). When the circuit is closed, current passes through the resistance (16) until the desired temperature, determined by the thermostat (17), is reached.

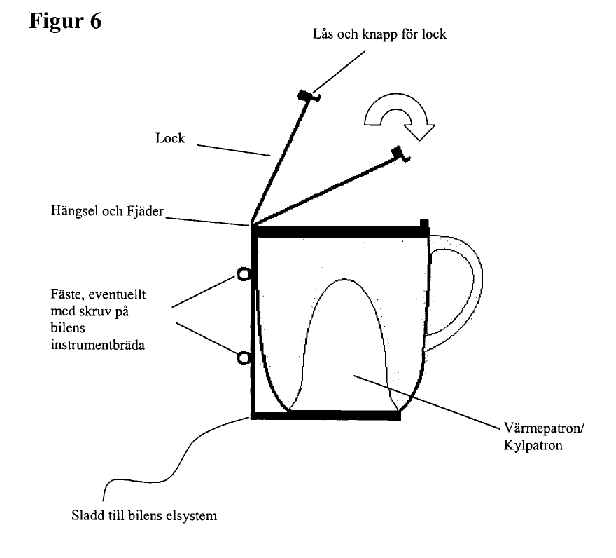

FIG. 6 is self-explanatory. It exemplifies how the invention can be used inside a vehicle such as a car.

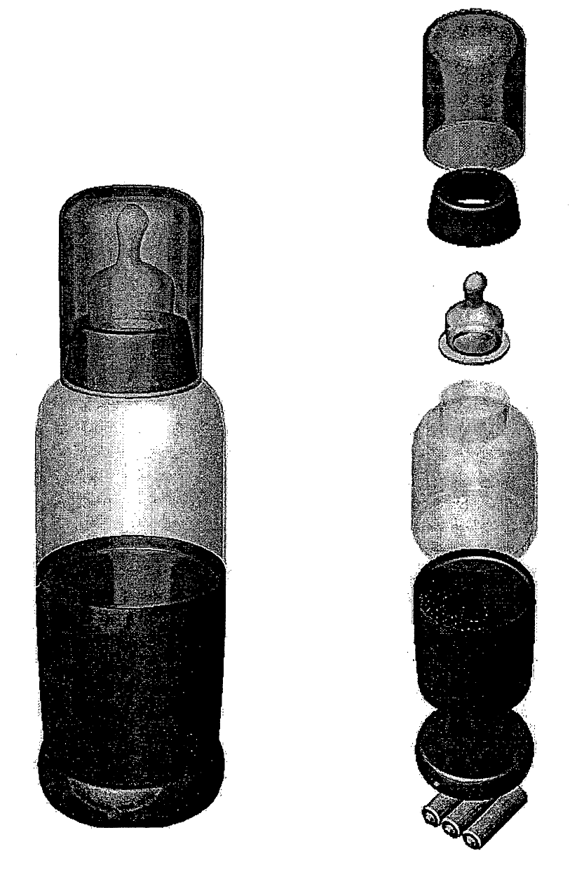

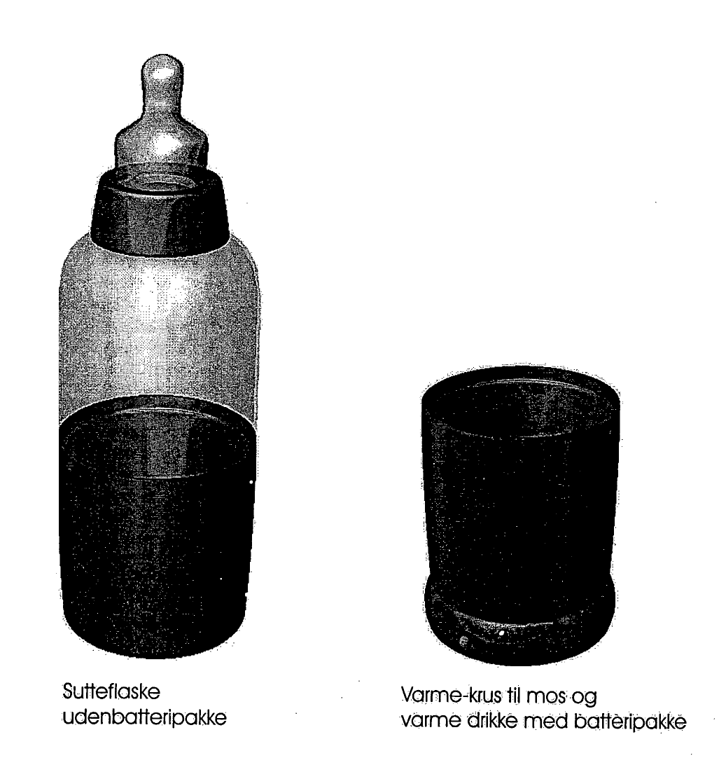

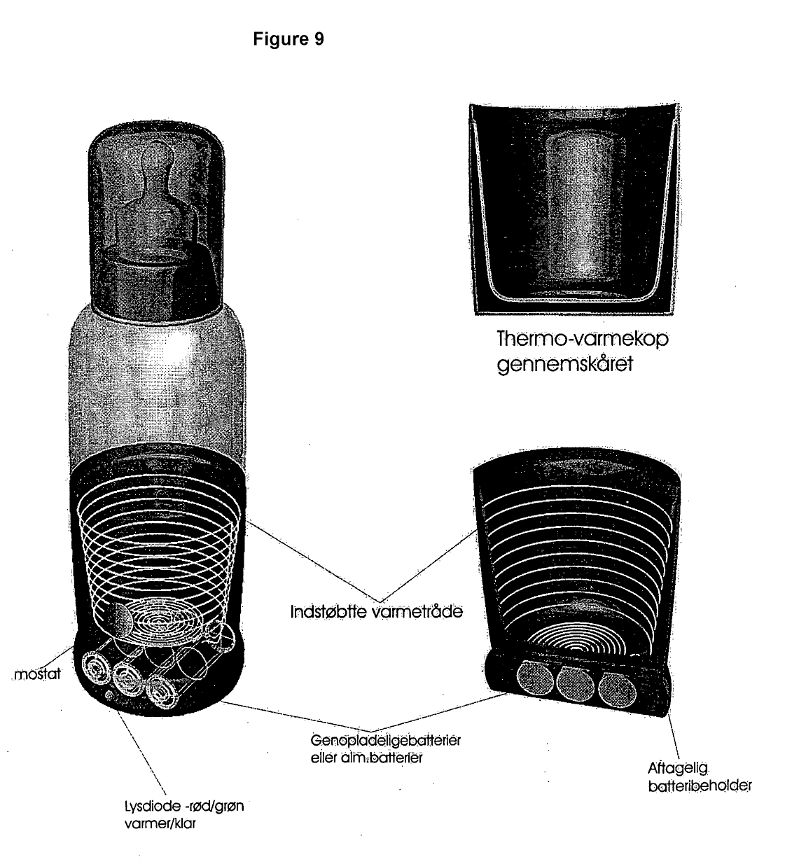

FIGS. 7, 8 and 9 show a further design of a modular, heated container (a feeding bottle). In this design, rechargeable batteries are housed in a charging module. On its top, the charging module has electrical contact surfaces that allow for the connection of a container with in-built heating coils. The charging module could have one or more LEDs and/or one or more displays or other means to indicate, visually or otherwise, temperature, time, charge status and/or other operating conditions for the modular heating device, To charge the rechargeable batteries, the charging module also has a means to connect it to a mains electricity supply. A container can be placed on top of the charging module. To draw current from the charging module, this container could conveniently have electrical contacts on its bottom. However, the invention is not restricted to being powered by one or more rechargeable batteries. Any energy storing technology whatsoever can be used to replace the batteries and achieve, in principle, the same effects. For example, ordinary (non-rechargeable) batteries could be used. In this case, it is unnecessary to provide a charging facility. This saves space and keeps manufacturing costs down.

In the present design example, heating coils around the container's side and at the container's bottom provide the means for transferring heat to the inside of the container. In this example, these heating coils are spiral in form but any other geometric arrangement could, of course, also be used. The modular, heated container in the present example shares, in principle, the same construction as previously presented examples. Thus, different modular arrangements can be put together so that the invention can be used in various ways. This modularity means that feeding bottle properties, puree heating properties and other properties can all be achieved depending on which modules are put together and used.

Even though the modules in the examples have been put together by means of screw threads, other means of joining modules can, of course, also be used.

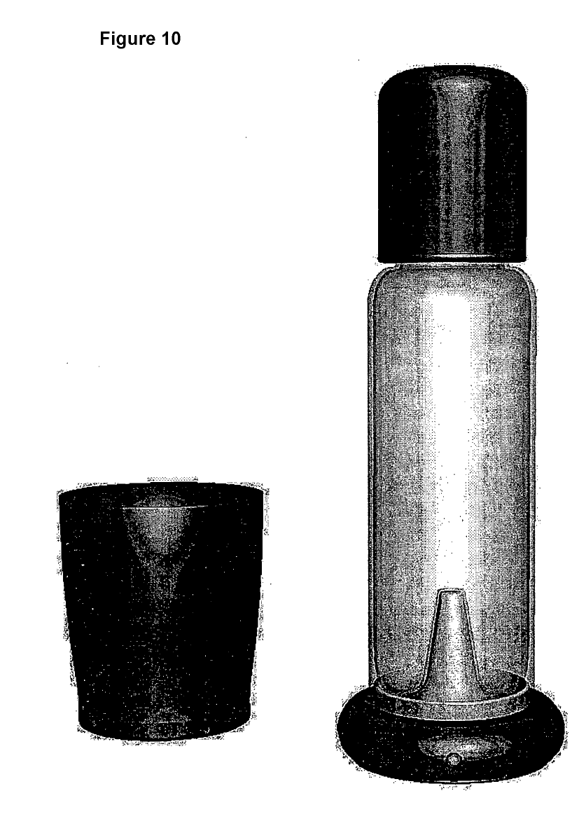

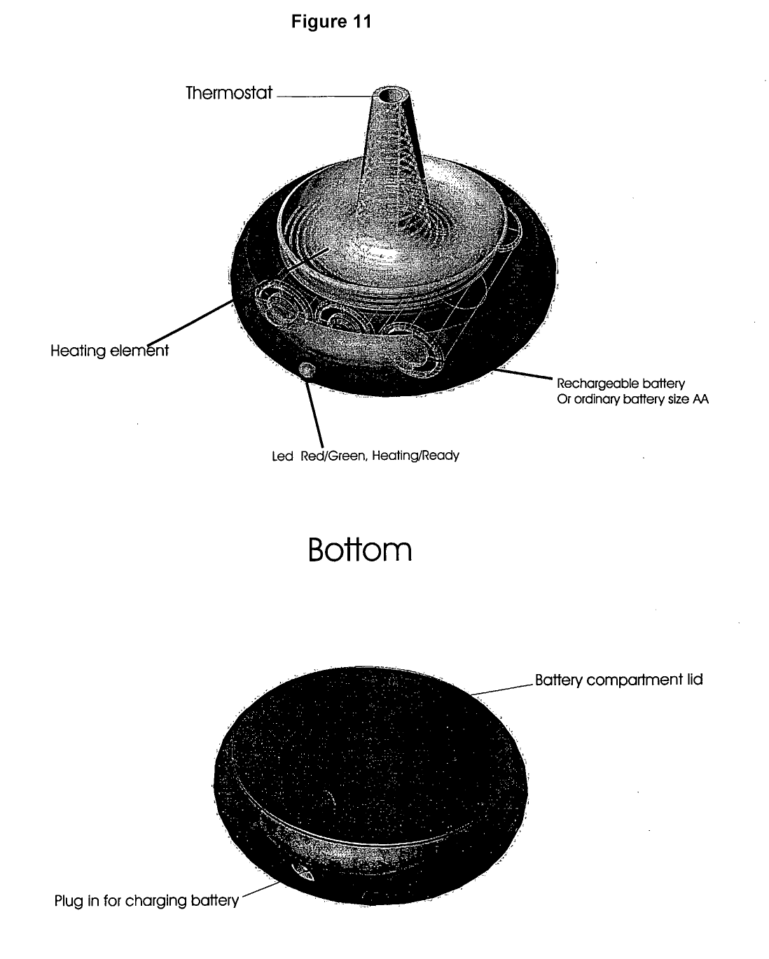

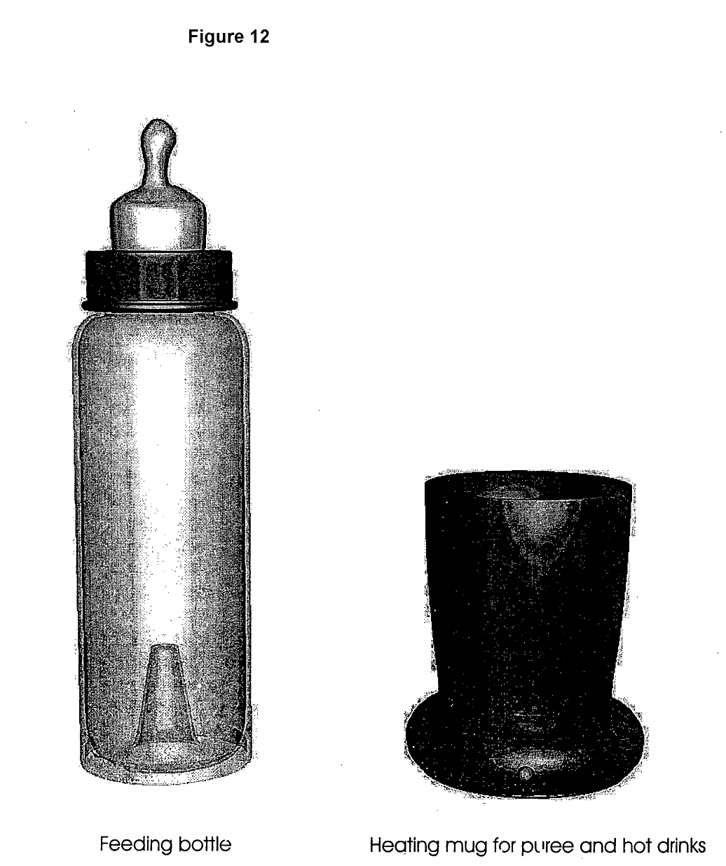

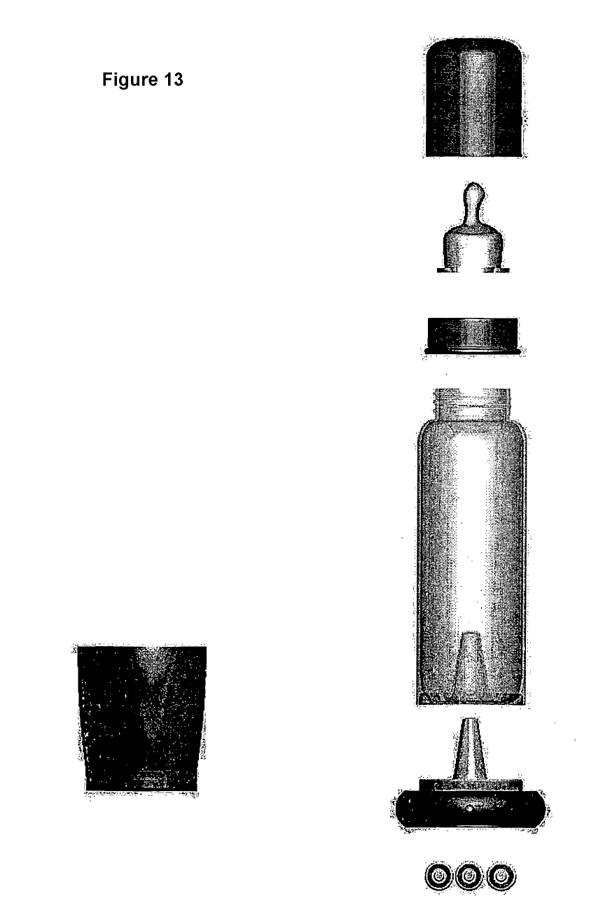

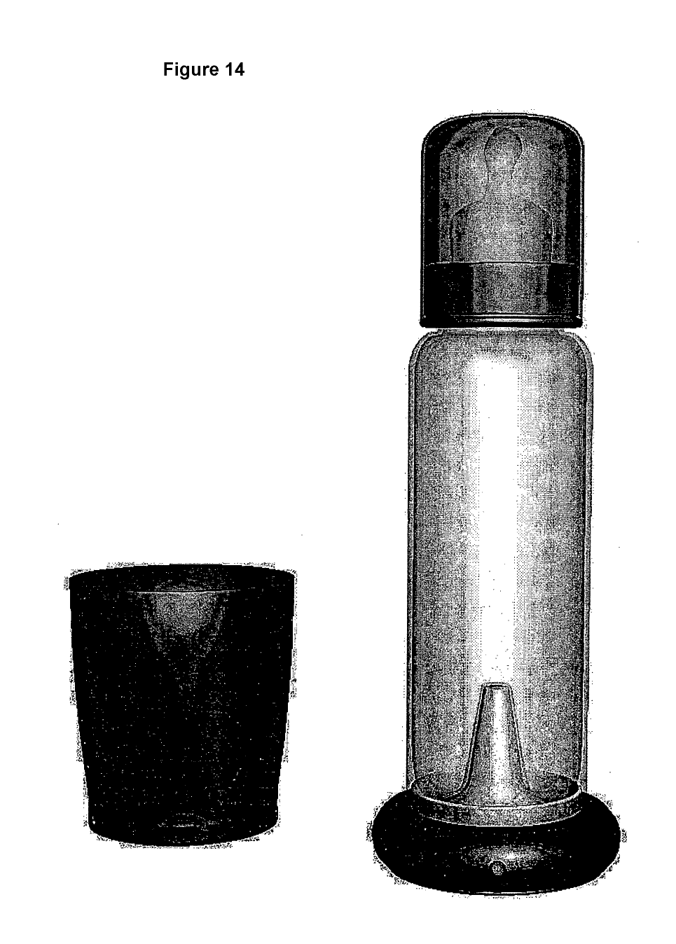

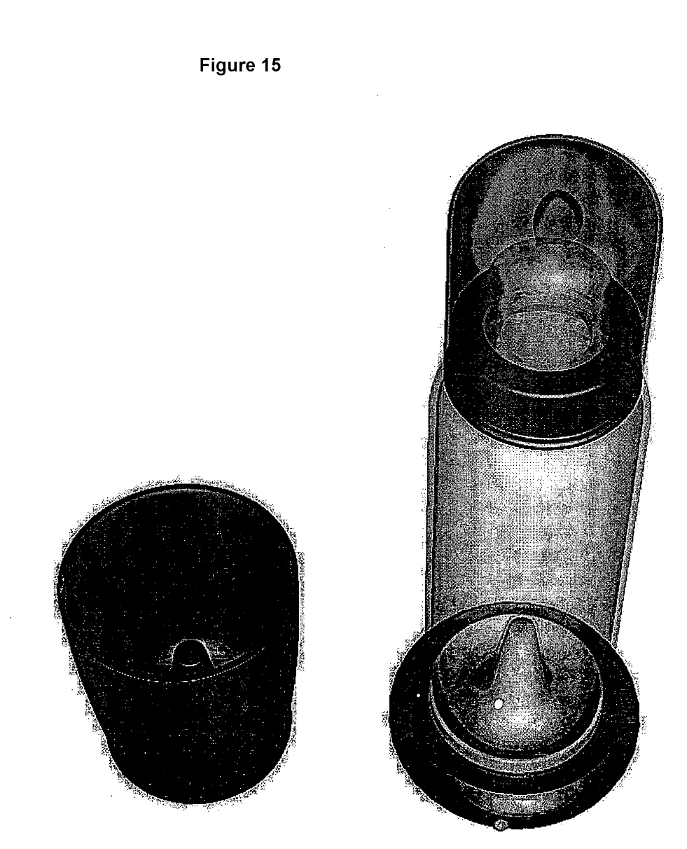

FIGS. 10-16 show a further design of a modular, heated container (a feeding bottle). In this design, rechargeable batteries are housed in a charging module that makes up the lower part of a heating unit. The charging module could have one or more LEDs and/or one or more displays or other means to indicate, visually or otherwise, temperature, time, charge status and/or other operating conditions for the modular heating device. To charge the rechargeable batteries, the charging module can also have a means to connect it to a mains electricity supply. However, the invention is not restricted to being powered by one or more rechargeable batteries. Any energy storing technology whatsoever can be used to replace the batteries and achieve, in principle, the same effects.

For example, ordinary (disposable) batteries could be used. In this case, it is unnecessary to provide a charging facility. This saves space and keeps manufacturing costs down.

In this design example, the heating unit comprises a battery compartment (charging unit) that has a conical top section. The conical top section has in-built heating coils. The heating unit could house a control for supplying current to the heating coils, which then generate heat. It could also be equipped with a thermostat. In this example, the heating coils are spiral in form but any other geometric arrangement could, of course, also be used.

A container can be placed on top of the heating unit. The container has a cavity designed to receive, and work with, the unit's conical projection. In this way, heat is transferred from the surfaces of the heating unit's shell, via the surfaces of the cavity's shell, to the container and its contents.

The modular heated container in the present example shares, in principle, the same construction as previously presented examples. Thus, different modular arrangements can be put together so that the invention can be used in various ways. This modularity means that feeding bottle properties, purée and compote heating properties, as also other properties, can all be achieved depending on which modules are put together and used. Where modules are put together to form a feeding bottle, the bottle body itself can be made up of two or more modules or cast in a single piece. The container can be made of any suitable material whatsoever.

The modules in the examples can be put together by means of screw threads. However, other means of joining modules can, of course, also be used.

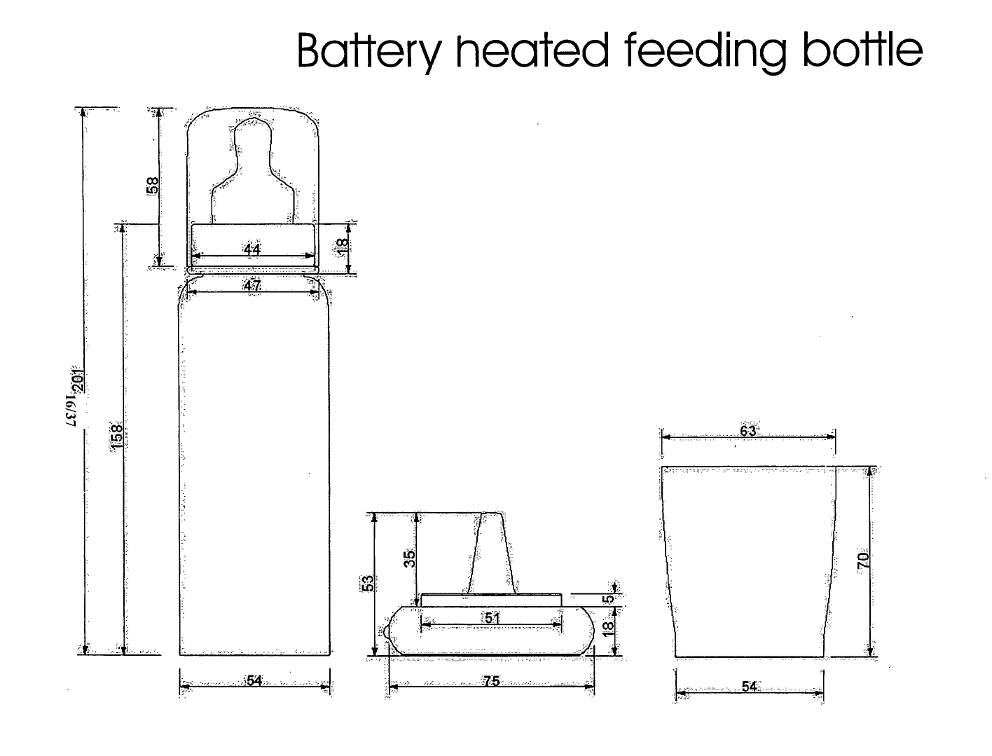

FIG. 16 gives possible dimensions of a feeding bottle as illustrated in FIGS. 10-15

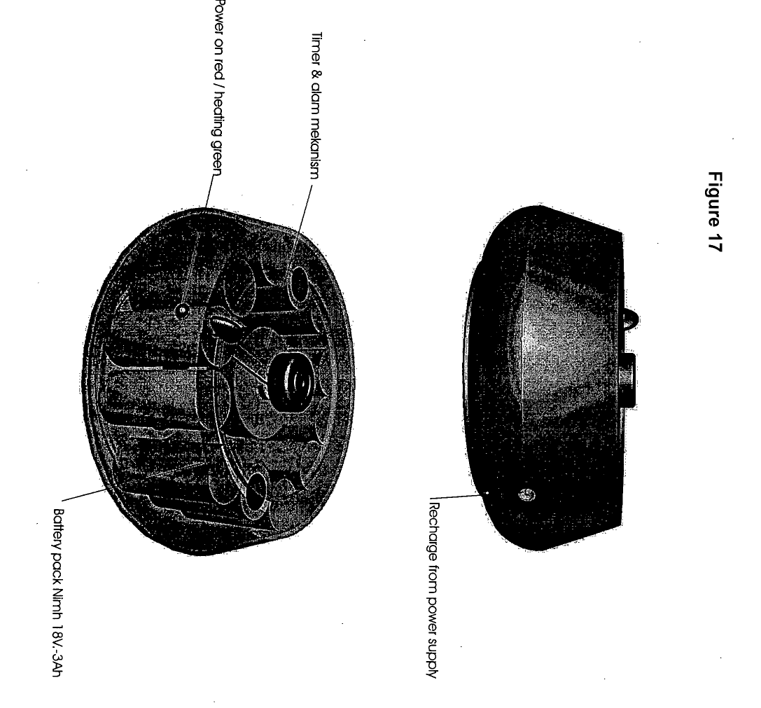

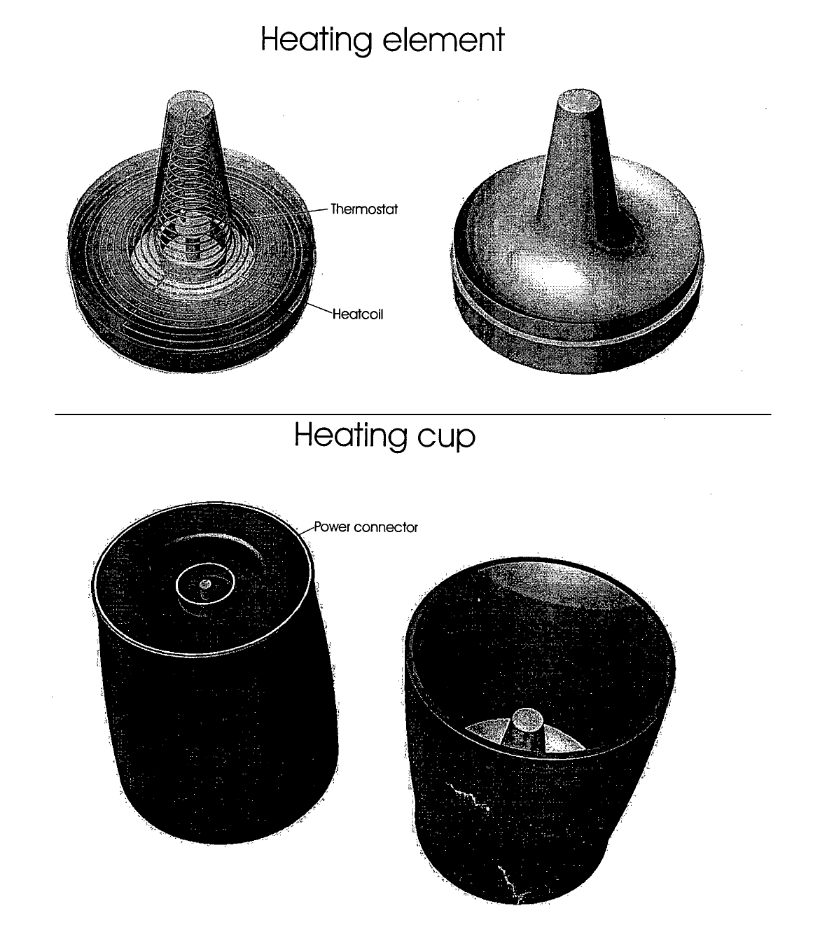

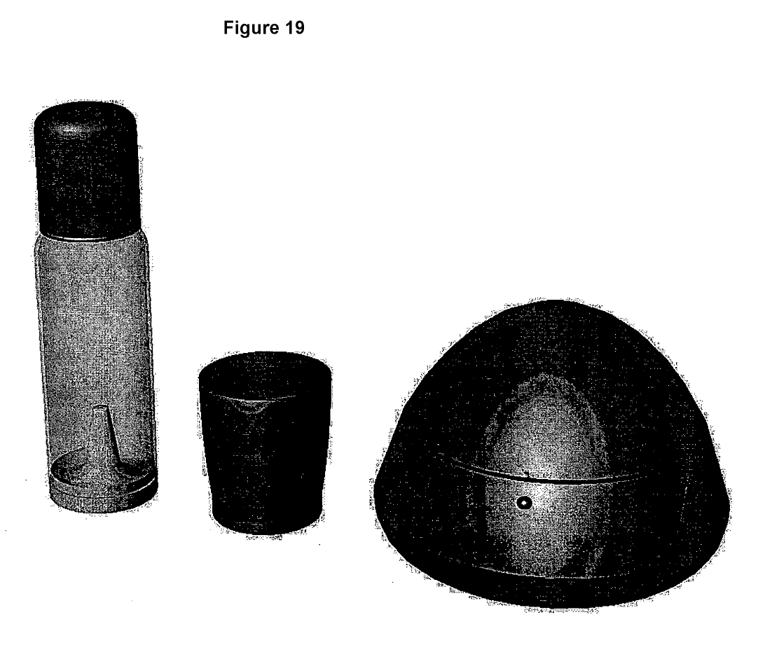

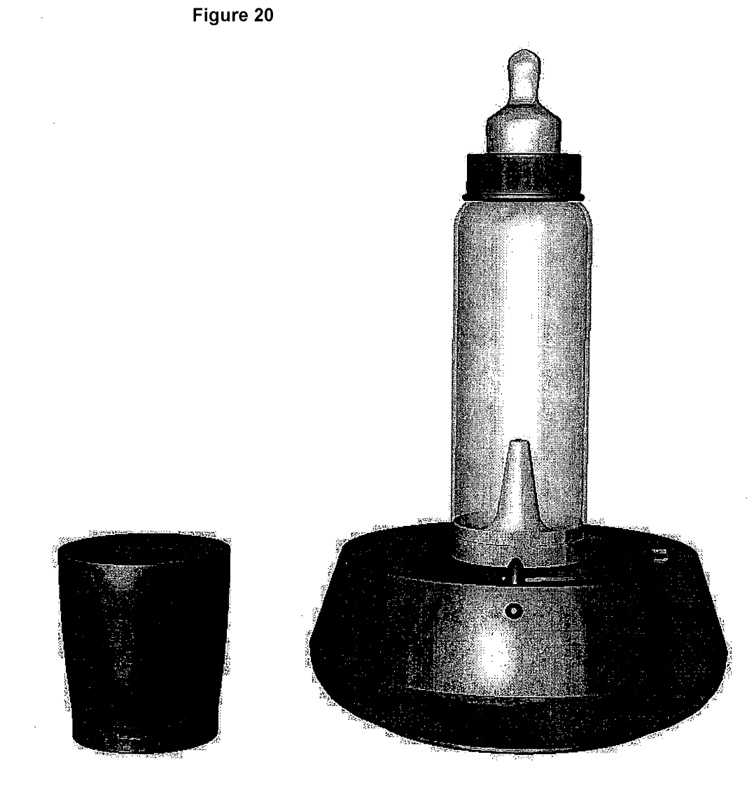

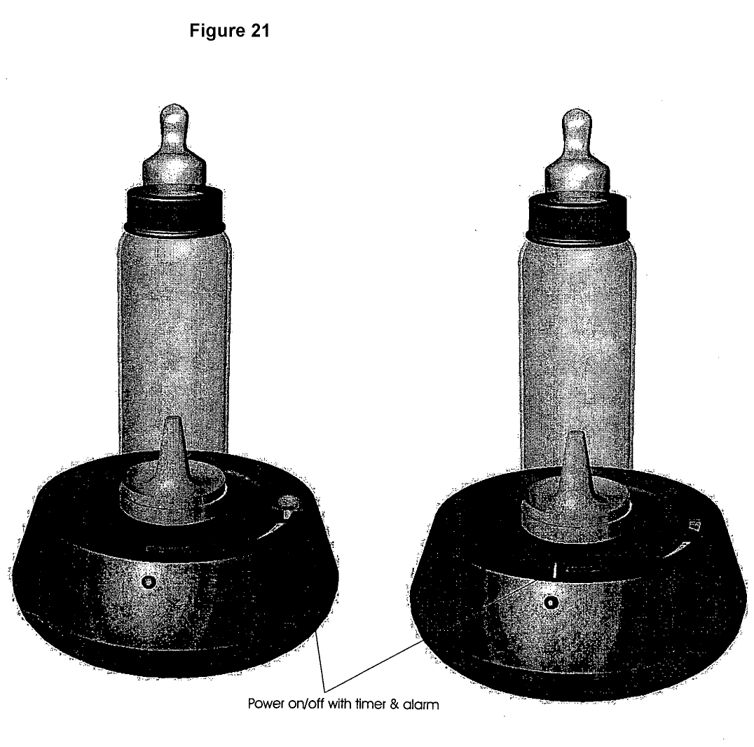

FIGS. 17-21 show yet another design example where batteries are used to provide heat. FIG. 17 shows the lower part of the heating unit. It is intended to function as a battery holder. The batteries can, for example, be of the ordinary type or, alternatively, rechargeable. The two higher pictures in FIG. 18 show the upper part of the heating arrangement. The resistance wire and the possibility of an in-built thermostat are clearly illustrated in the picture on the left. The two lower pictures in FIG. 18 show a possible design of a container section. In this case, the container provides a mug and has a cavity that encloses the top section of the heating sections. The pictures also show how, via a contact, the container can be connected to the heating unit and its batteries. As shown in FIG. 19, the heating unit can also be provided with a protective cover, which must be removed before the container section can be placed on the unit. FIG. 20 shows the protective cover removed from the heating unit and how a container section can then be placed on this unit. FIG. 21 shows a feeding bottle placed on the heating unit. It also shows that the heating unit can be equipped with a switch and have timer and alarm functions.

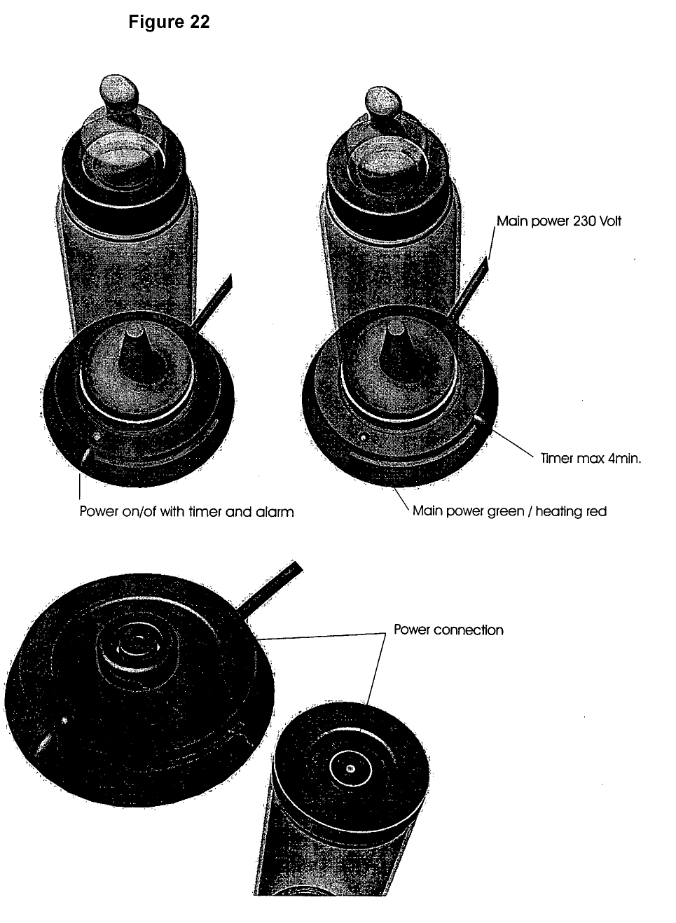

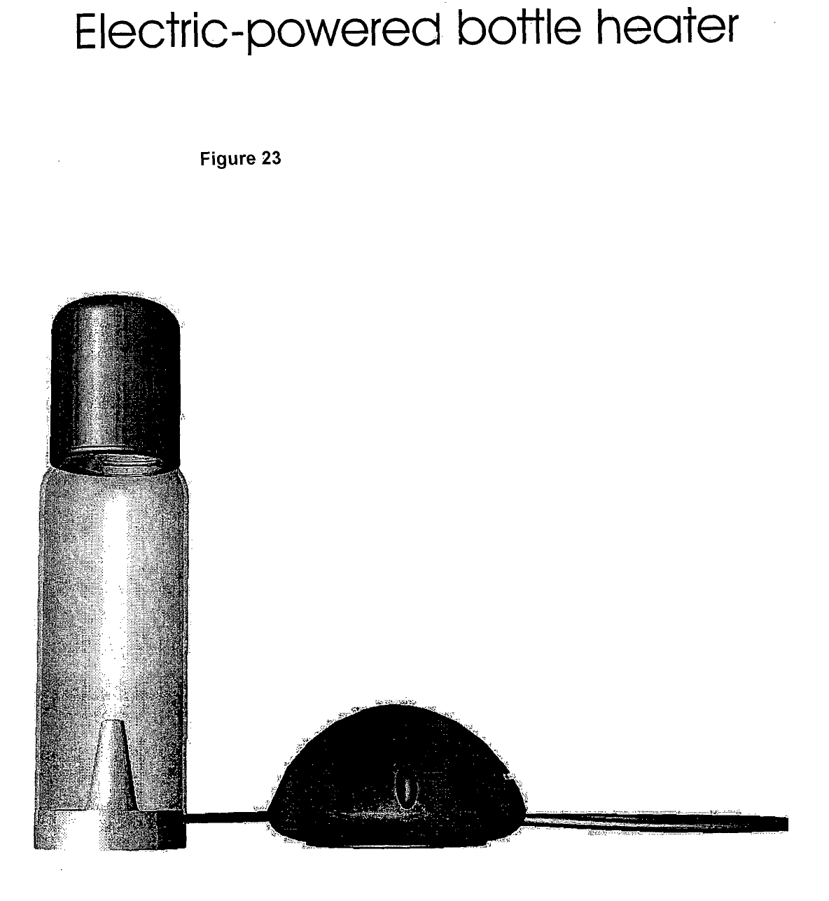

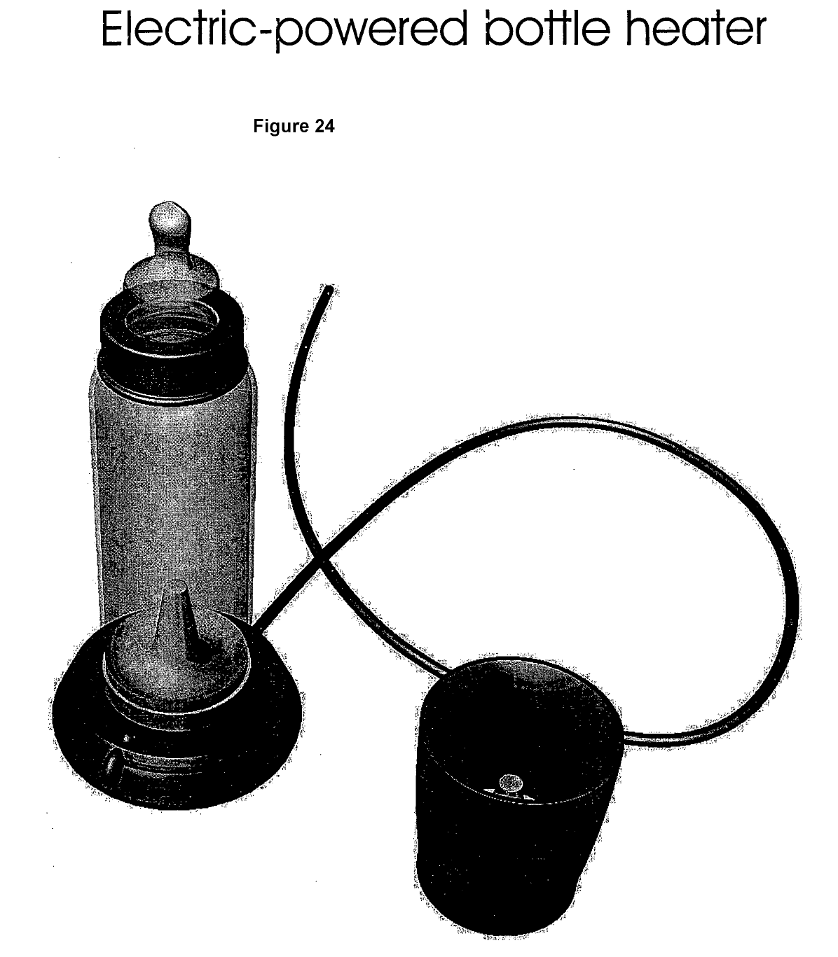

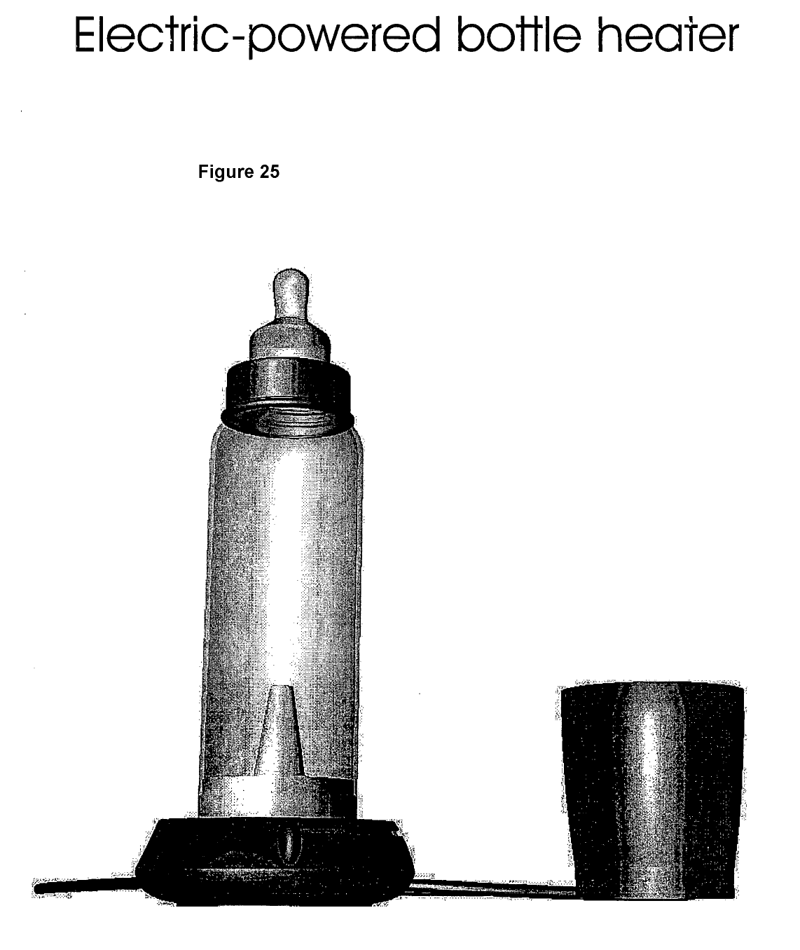

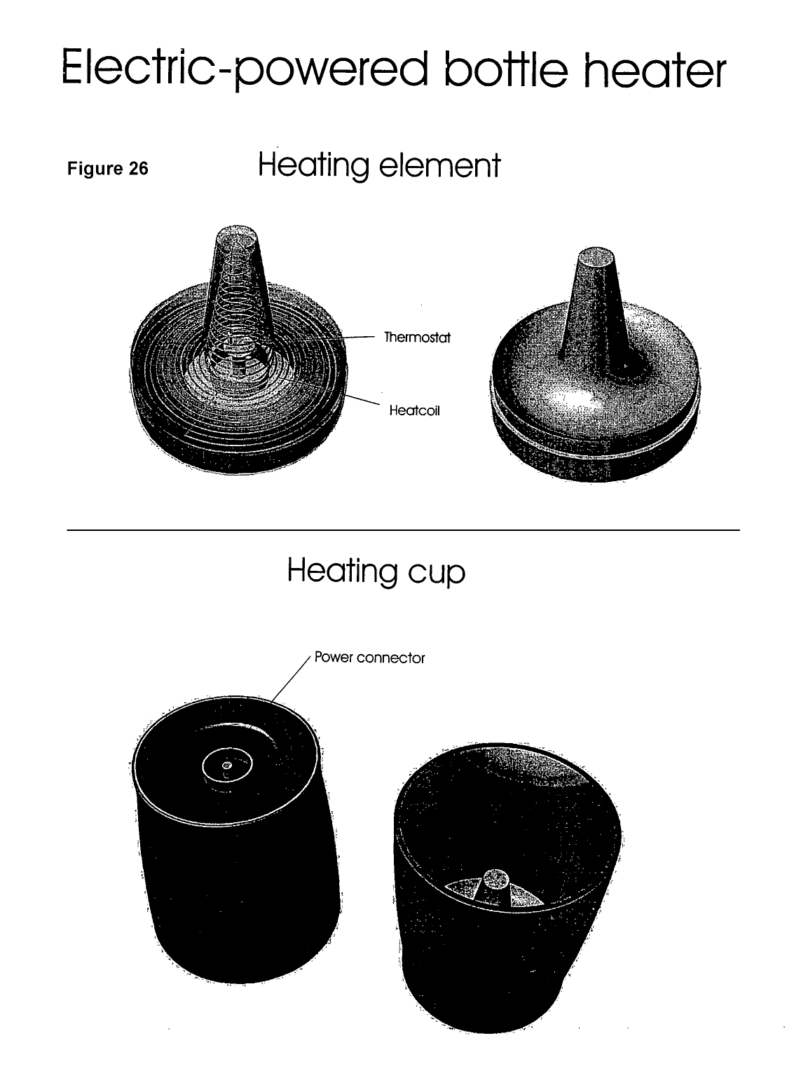

FIGS. 22-26 show electrically heated containers such as feeding bottles and mugs.

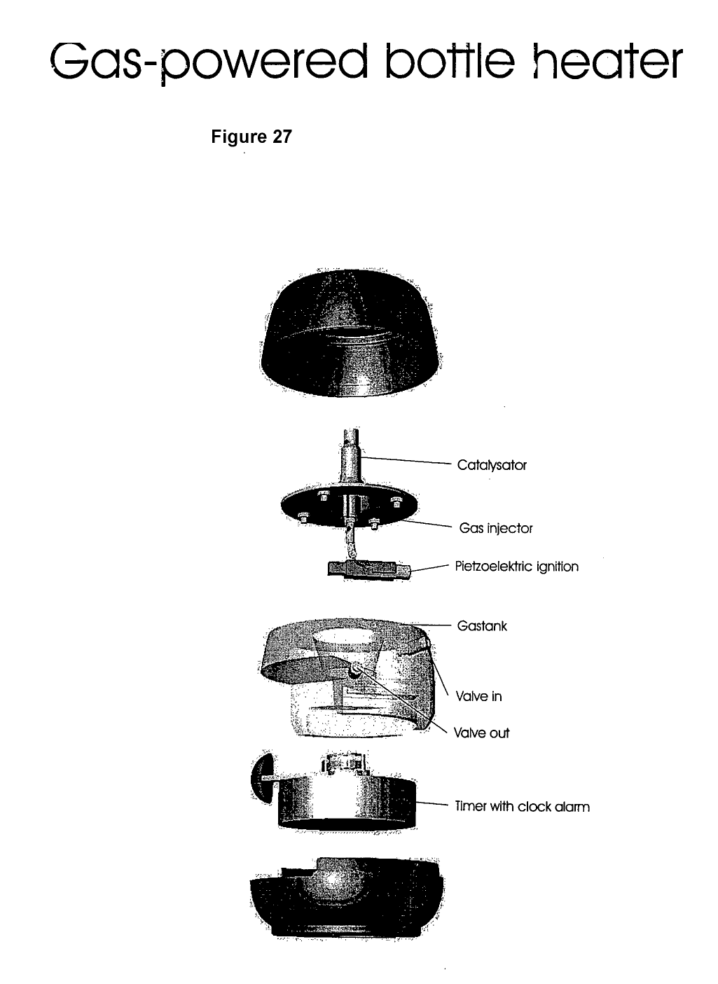

FIGS. 27-34 show portable, gas-heated containers (e.g. feeding bottles and mugs) and their constituent parts. Gas, which can be generated in a number of ways, can be used to heat the contents of the container. Naturally enough, it is possible to have a ready-made gas container to supply the gas, but it is also possible to use chemical substances that, when mixed, generate a gas.

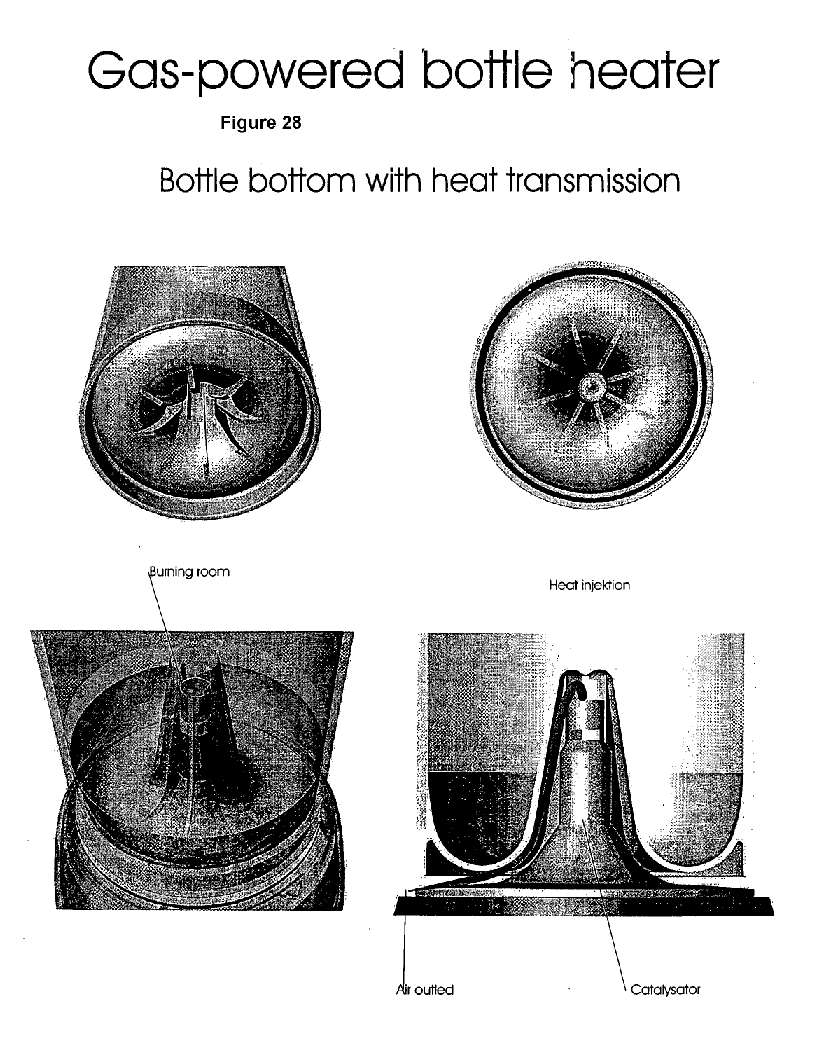

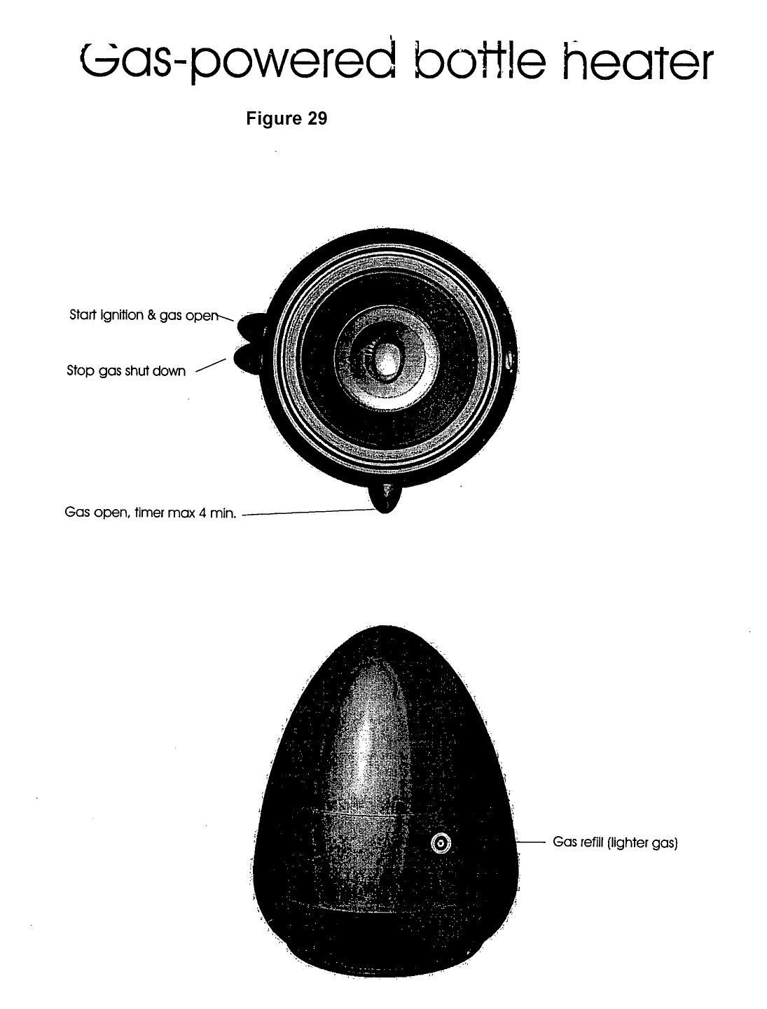

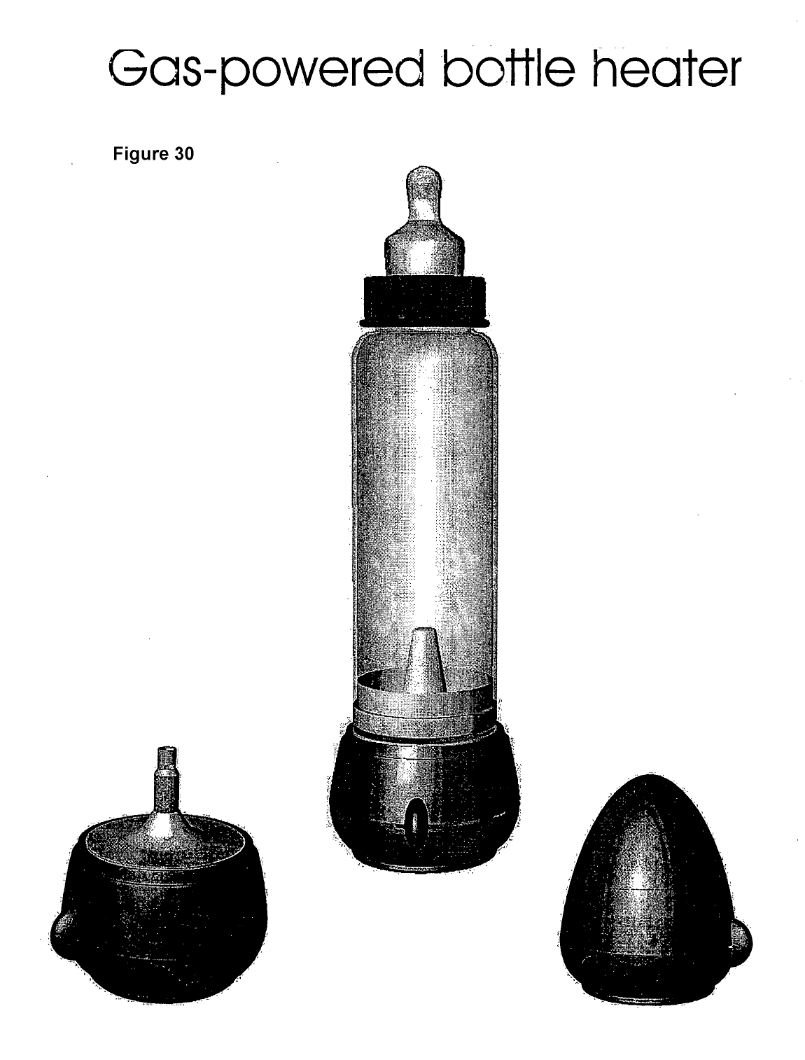

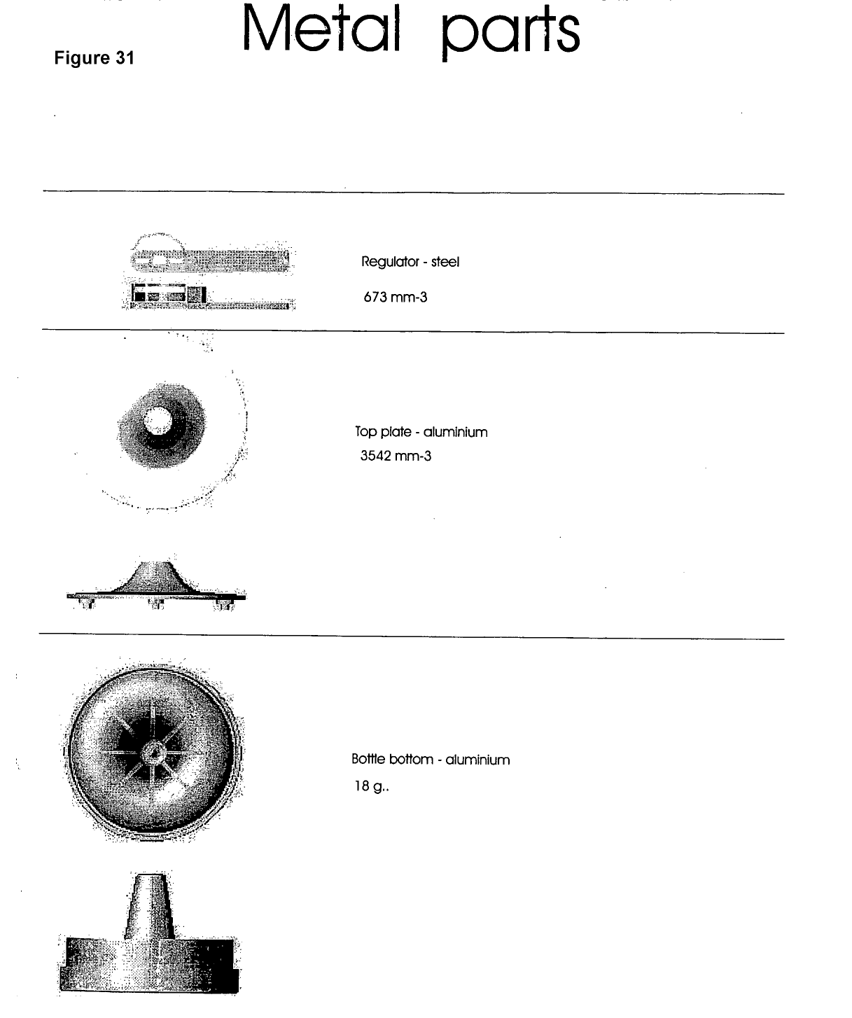

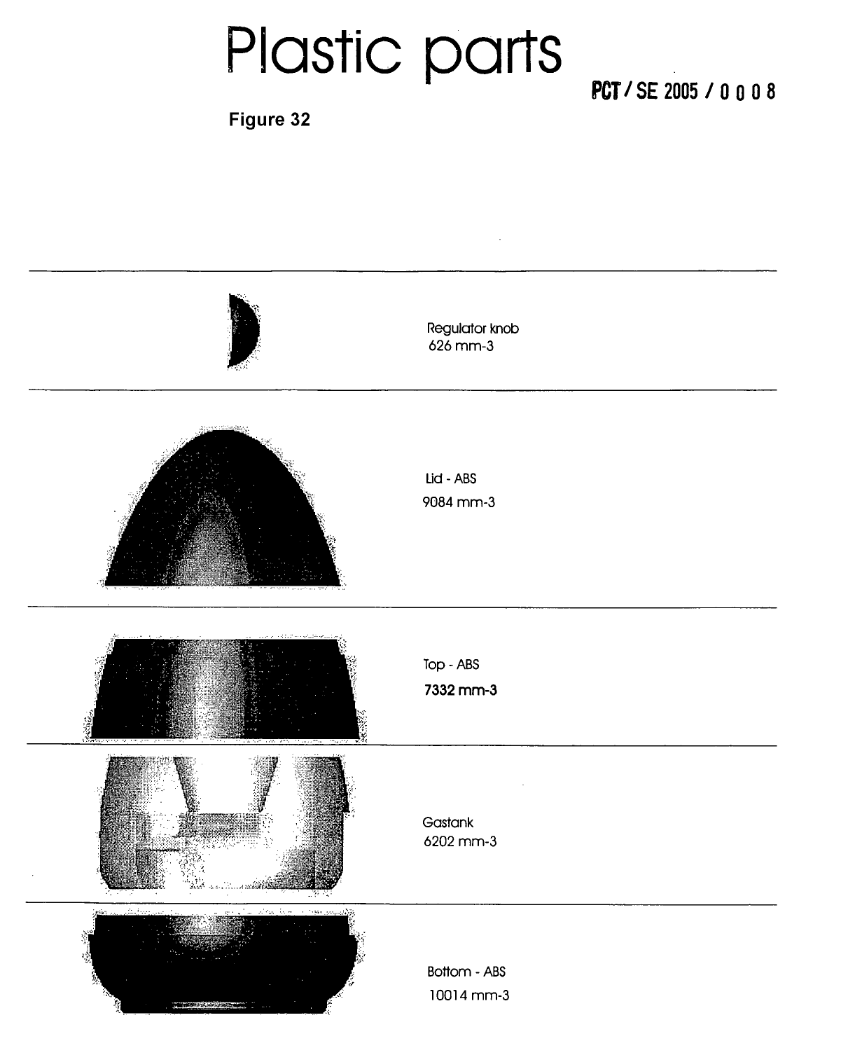

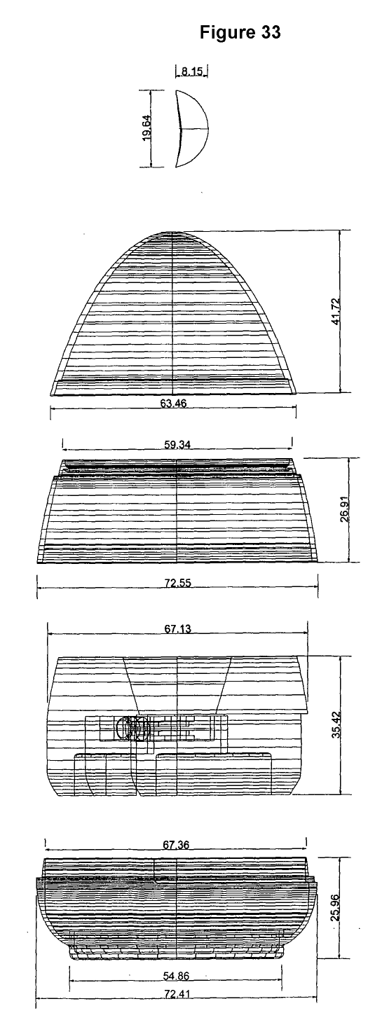

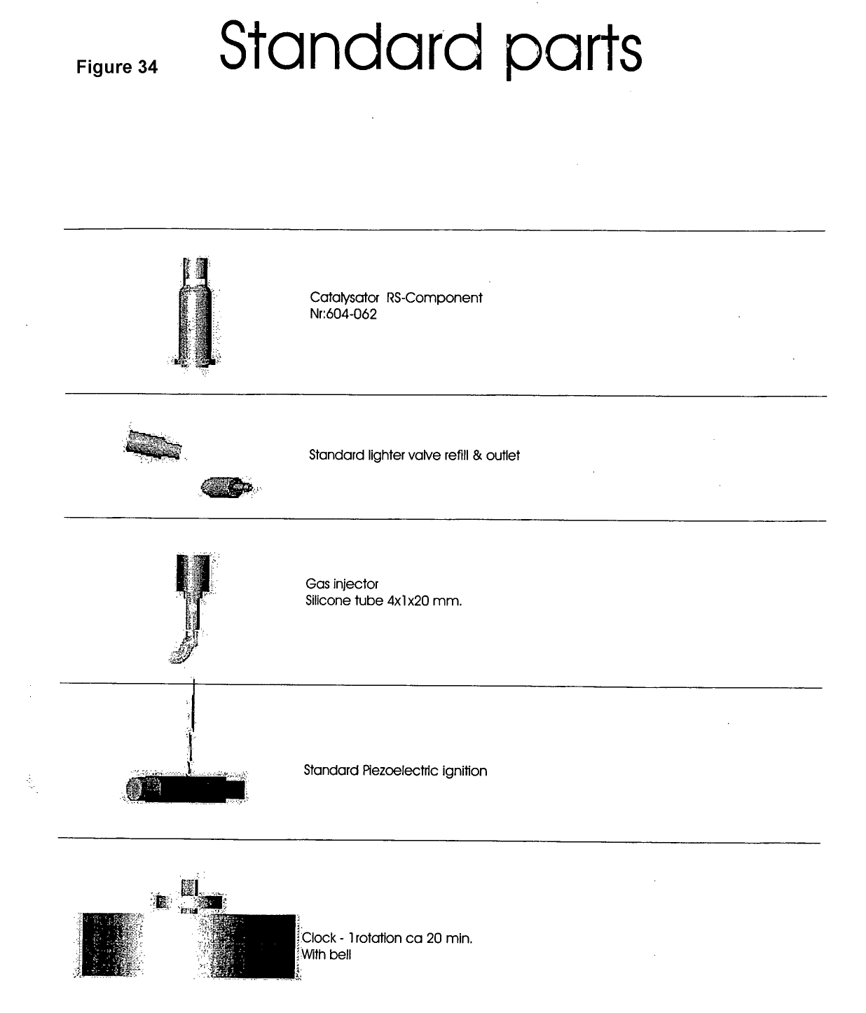

FIG. 27 is an exploded view of the heating unit for a gas-heated container. Besides the various components, it further shows that the heating unit can be equipped with timer and alarm functions. FIG. 28 shows the bottom of a container, in this case a feeding bottle, and how heat is transferred from the heating unit to the bottle. FIG. 29 shows the heating unit directly from the underneath. It also illustrates where the means for starting and stopping the unit can be sited. The lower pictures show the heating unit with a protective cover. FIG. 30 shows a heating unit without a protective cover, a container section (a feeding bottle in this case) that works in conjunction with the gas heating unit and a heating unit equipped with a protective cover. FIG. 31 shows the parts of the arrangement that can be made of metal. FIG. 32 shows the parts of the arrangement that can be made of plastic. FIG. 33 shows dimensions that may be suitable for the heating unit. FIG. 34 illustrates standard parts used in the manufacture of a gas-heated container.

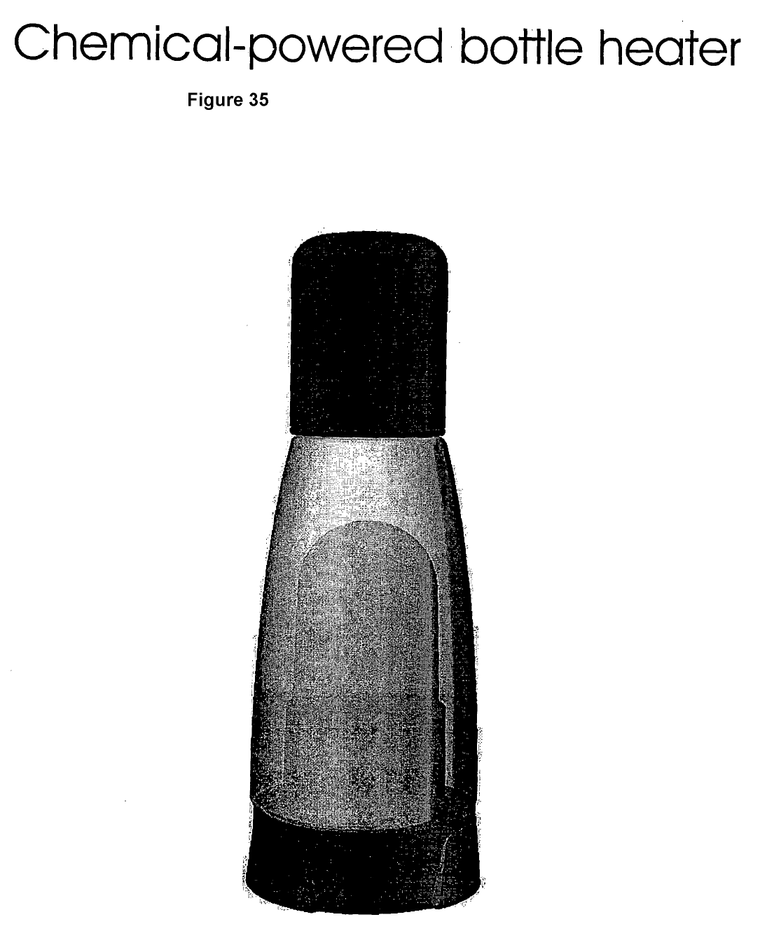

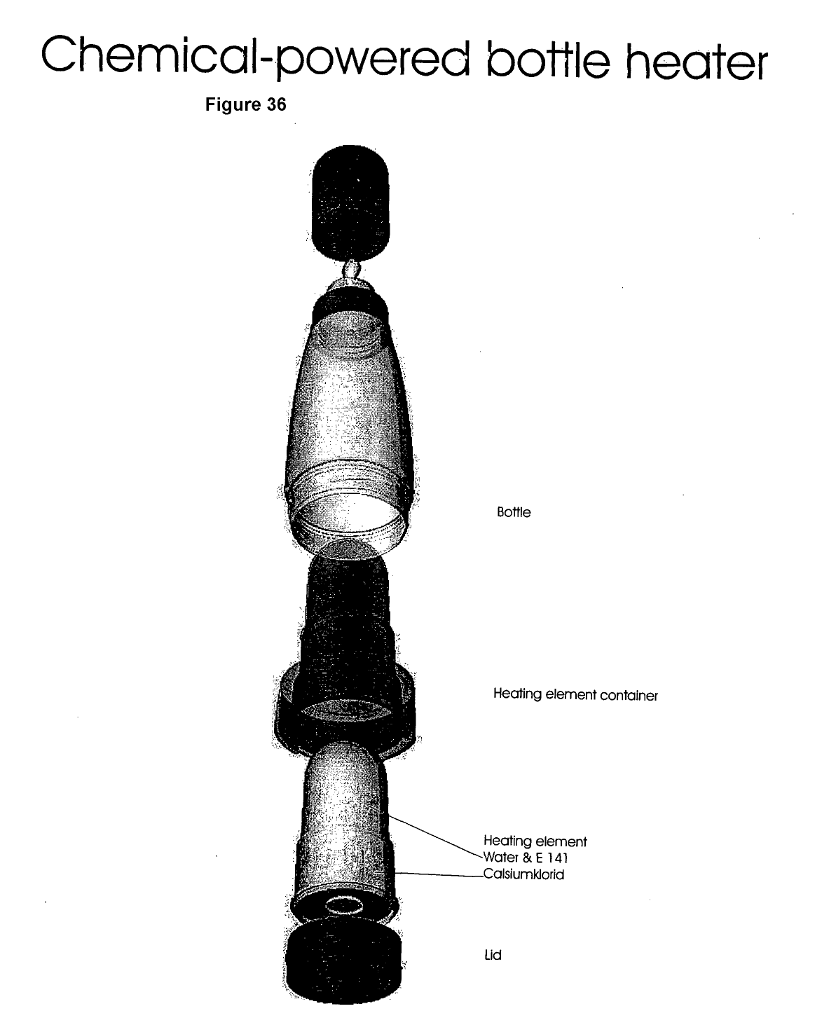

FIGS. 35 and 36 show a chemically heated feeding bottle. FIG. 36 is an exploded view of such a feeding bottle. It shows a sealing cap, a teat, the container itself, a separate bottom section (which screws to the container) and a unit that contains the chemical means for generating heat.

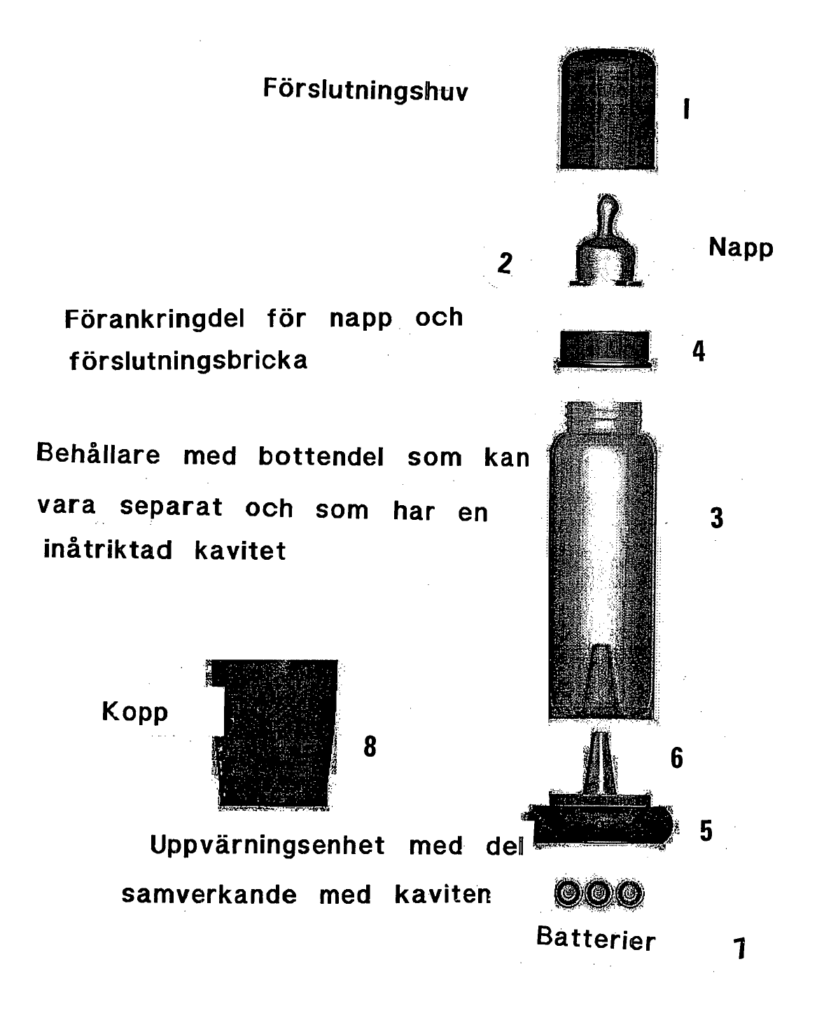

FIG. 37 shows a reference illustration of a feeding bottle with a heating device. The parts include a sealing cap and a teat that, using an anchoring component (which can also be used in conjunction with a sealing disc), can be fitted to a container. The sealing cap can be so designed as to form a drinking cup. The container can be produced as a single, coherent part. It could also have a separate bottom section (with an inward projecting cavity) that attaches to the container in one way or another. A heating unit is attached at the base of the container. The unit has an outward projecting section that is designed to fit into the aforementioned cavity. In the present case, the heating unit is electrical and requires batteries. The aforementioned outwards projecting section of the heating unit has an internal resistance wire that, when a current is applied, gives off heat to whatever is in the container.

### Baby Bottle with Built-In Heating System—General Comments

The heating needs to stop at 37° C. The obvious solution to this is to install a temperature sensor and power off the device at 37° C. This, however, has several drawbacks. An electrical sensor would mean that in the gas-powered and the chemical model a battery and control circuit would have to be added. This would have to control a valve in case of the gas model, but in case of the chemical model there is no way of interrupting the heating process other than removing the cartridge. Making the electrical connections between the sensor placed in the milk and the turn off mechanism in the base is also an added complication.

But the most fundamental objection to a temperature sensor is the problem of placement. During heating, especially rapid heating, there can be rather large temperature differences between different places in the milk. In the gas-powered prototype we have tested, a temperature difference of 8° C. was measured. This makes the question of placement non-trivial. If we disregard the aspects of cost, complexity and ease of cleaning, the solution would be to place several sensor at different locations in the milk, continuously calculate the mean temperature and interrupt the energy flow when 37° C. is reached. This solution is of course not an option. So we have opted for a combination of a timer mechanism and a passive, i.e. non-electrical, temperature indicator. The latter could be an array of liquid crystal indicators as found in baby bath thermomoters. The suggested use is to add the cold milk, set the timer to maximum, wait until it stops, lift the bottle of the base, turn it over to even out any temperature differences, and finally check the temperature. On cold days, or with more milk, it will then be necessary to repeat the procedure until 37° C. is reached.

Finally it should be noted that the suggested solutions are not limited to milk or 37° C.. They could for example be used for heating soup to 80° C. if need be.

### Baby Bottle with Gas-Based Heating System

The following is a brief technical note on experiments with the baby bottle with built-in heating system based on the combustion of butane gas.

The bottle itself is similar to a standard baby bottle apart from the aluminum bottom. This bottom has been made to fit over the correspondingly shaped aluminum top of the separate and detachable heater. When the heater is on, the hot air is guided through a narrow space between the two aluminum parts, thus insuring effective transfer of heat.

The energy for heating comes from the combustion of butane, which can be burned with or without a catalyst. Both variants have been successfully tested. The bottle is filled with milk and placed on the base unit containing the gas and ignition system. Then the actuator is rotated clockwise, opening the gas inlet valve and firing the spring-operated piezo-electric igniter. This is very similar to turning on a gas stove. Then the actuator is rotated counterclockwise to the desired time indicator. The longest time eligible, should correspond to heating a bottle of milk at the highest power level. If a lower power setting or larger amount of milk is used, the heating procedure can be repeated. The gas container holds approx. 40 ml of gas, with a total energy sufficient for heating a bottle of cold milk more than 30 times. Refilling the gas container is done using a system like the one on a refillable lighter.

For all the tests 150 ml of milk, with initial temperature of 7° C. were used. Assuming that milk has the same heat capacity as water, we need to supply an amount of energy given by:

ΔE=m·c·ΔT=0.15kg·4.2kJ/(kg·K)·30° C.=19kJ

Three different experiments were carded out:

Normal combustion, high gas supply: Heating time 2 minutes, equals approx. 150 Watt,

Normal combustion, low gas supply: Heating time 3 minutes, equals approx. 100 Watt.

Catalytic combustion, low gas supply: Heating time 6 minutes, equals approx. 50 Watt.

By heating the milk fast you get a large temperature difference between the top and bottom of the bottle, I measured up to 8° C. difference. After heating, this difference disappears quickly due to convection, or the bottle can be turned upside down. In none of the tests did the milk become burnt, and the bottle is no warmer than the milk so it can be handled bare handed. The low thermal mass of the aluminum bottom, means that it will have the same temperature as the milk. So you can not burn your fingers even if you touch the metal right after heating. The heating element itself does become very hot, but this part does not go near the child, so I do not consider this a problem.

### Baby Bottle with Battery Powered Heating System

The following is a brief technical note on the baby bottle with built-in battery powered electrical heating system. The bottle itself is similar to a standard baby bottle apart from the aluminum bottom. A heating coil is imbedded in the bottom, and a central pirouette plug connects the heating coil to the base, which contains the batteries.

In order to heat the liquid we need the same 19 kJ as for the other models. If we want to heat the liquid from an initial temperature of 7° C. to 37° C. in 3 minutes we need approx. 100 Watts of power.

$$\begin{matrix}P = Δ E / Δ t \\ = m \cdot c \cdot Δ T / Δ t \\ = 0.15 kg \cdot 4.2 kJ \text{/} ( kg \cdot K ) \cdot 30 °C . / 180 s \\ = 105 Watts\end{matrix}$$

This demand for power can be met in at least two ways: Using a series connection of high-capacity rechargeable standard size batteries or using a custom battery. The technical specifications of the batteries chosen for the first calculations match those of Panasonic rechargeable NiMH 1.2 V, size C cells.

The maximum discharge current is approx. 6 A, meaning that in order to reach 100 Watts we need 18 V, which means 15 cells connected in series. This makes the total weight of the batteries 850 g, and this explains the rather large base unit. This battery assembly would have enough energy for 10 heating cycles. Other manufacturers of batteries claim that 10 cells would be enough. The price quote is for 10 cells. Other candidates could batteries of the type used in powertools. Depending on which feature of the bottle one wishes to improve the heating system could be made: Faster but still, heavy, large and expensive. Smaller, lighter and cheaper but not faster. Assuming that the latter alternative is the most interesting a battery like the DeWalt DE9057 could be used. The specifications are 7.2 V, 90 W max, 380 g, 1700 mAh. This battery would have enough energy for 2 heating cycles before needing recharging. Of course there are many other possibilities in between the ones mentioned here. The final choice would be a compromise between size, price, capacity and power.

Please refer to the calculation in the note on the bottle with gas-based heating system for details.

### Baby Bottle with Electrical Heating System

The following is a brief technical note on the baby bottle with built-in electrical heating system based.

The bottle itself is similar to a standard baby bottle apart from the aluminum bottom. A heating coil is imbedded in the bottom, and a central pirouette plug connects the heating coil to the base, which plugs into the wall outlet. This model has the very important advantage over the other models, that it has an inexhaustible energy source. If we want to heat our test sample of 150 ml milk in 3 minutes we need 100 Watts. A standard electric kettle is approx. 2000 Watts. so there is no question that this is feasible. Obviously the heating time can be drastically reduced, and the main problems will be stopping at the correct temperature, and avoiding burning the milk.

The main difference between this bottle and a standard electric kettle is the fact that the heating must stop well before boiling occurs, and consequently a steam sensor can not be used to terminate the heating. Instead the base upon which the bottle rests could be fitted with a timer and an alarm. The user turns a dial, which corresponds to a certain time. When the time is up, the bottle is removed, turned upside down a couple of times to ensure a uniform temperature, the temperature is checked, and if the milk is not warm enough, the procedure is repeated. The only disadvantage of this model is the need for a power outlet.

### Baby Bottle with Built-in Chemical Heating System

The following is a brief technical note on the baby bottle with built-in heating system based on the dissolution of anhydrous CaCl2 in water.

The bottle itself is similar to a standard baby bottle apart from the bottom. The bottom is hollow allowing the disposable cartridge to be inserted. Once in place, the seal between salt and water is broken by pressing the bottom of the cartridge.

Once the seal is broken the salt quickly dissolves and the heat is released to the surrounding milk.

This model has two distinguishing features compared to the three other models: It is very fast and it can not be turned off. The energy from the chemical reaction is released to the milk in about 60 seconds. This is obviously an advantage. Furthermore the bottle does not have a base unit like the others. The heating cartridge is inside the bottle and need not be removed prior to ingestion of the milk, but it will be a little heavier with the cartridge present. The water used in the chemical reaction contains green food colouring E141. This is to ensure that in the very unlikely event of a leak, it will be noted immediately. Should a leak go undetected, the CaCl2 in the milk will make it taste horrible thus discouraging the child from ingesting it.

Chemically CaCl2 is very similar to NaCl2, which is ordinary table salt. So drinking a mouthful of milk with CaCl2 with not be anymore hazardous than drinking salted milk. It seems unlikely that anyone would drink large quantities of this. Should this nonetheloss happen, CaCl2 is an effective emetic (kräkmedel). Normally CaCl2 is used in pellet form as road deicer.

The fact that the heat can not be turned off, means that the same amount of energy will be released to the milk regardless of amount and initial temperature. Therefore this model should be used with a fixed amount of milk at a specified temperature, e.g. 150 ml of milk taken directly from the refrigerator. If need be cartridges containing different amounts of CaCl2 could be made corresponding to different amounts of milk.

1. Modular, portable foodstuffs container (preferably for liquid foodstuffs) that has an opening for emptying and filling and which, preferentially, can be used in conjunction with a teat, the said container having, preferably at its base, a temperature generating (i.e. heating/cooling) arrangement, the whole being characterised by the container having an inward projecting cavity that interfaces with all or part of the temperature generating arrangement, it being possible for the container itself to be made up of a number of modules.

2. Modular, portable foodstuffs container as per patent claim 1, characterised by the temperature generating arrangement being electric and using an external or internal power source that is designed to send current through a resistance wire and thus cause it to give off heat.

3. Modular, portable foodstuffs container as per patent claim 2, characterised by said wire being an integrated part of the temperature generating arrangement, either in the container wall or in a component attached to the container.

4. Modular, portable foodstuffs container as per claim 1, characterised by the temperature generating arrangement, or parts thereof, being in a separate unit that is separately fastenable to a free range of objects (e. g. vehicles and bicycles).

5. Modular, portable foodstuffs container as per claim 1, characterised by the temperature generating arrangement using chemical substances that, either wholly or partly, may be gaseous, or brought to gaseous condition, and which, either in interaction with each other or independently, can generate heat.
